(19) United States
(12) Patent Application Publication
(10) Pub. No.: US 2025/0177095 A1
(43) Pub. Date: Jun. 5, 2025

(54) MULTI-DIMENSIONAL SKELETAL CORRECTION AND AIRWAY CORRECTION

(71) Applicant: Align Technology, Inc., San Jose, CA (US)

(72) Inventors: Jun SATO, San Jose, CA (US); Srinivas KAZA, Mountain View, CA (US); Mitra DERAKHSHAN, Herndon, VA (US)

(21) Appl. No.: 18/969,243

(22) Filed: Dec. 4, 2024

Related U.S. Application Data
(60) Provisional application No. 63/606,087, filed on Dec. 4, 2023.

(51) Int. Cl. A61C 7/10; A61C 7/36

(52) U.S. Cl. CPC A61C 7/10; A61C 7/36

(57) ABSTRACT

Multi-dimensional skeletal corrections that can provide a comprehensive and total multi-dimensional treatment solution to treat one or more complex oral and/or airway conditions may concurrently include palatal expansion and mandibular advancment. For example, these methods and apparatuses, including systems and devices, as well as software, hardware and firmware, may be used to treat complex and potentially interrelated conditions such as (but not limited to) Class II and Class III malocclusions, narrow maxillary arch, and obstructive sleep apnea.

### CLAIM OF PRIORITY

This patent application claims priority to U.S. provisional patent application No. 63/606,087, titled “MULTI-DIMENSIONAL SKELETAL CORRECTION,” filed on Dec. 4, 2023 and herein incorporated by reference in its entirety.

### INCORPORATION BY REFERENCE

All publications and patent applications mentioned in this specification are herein incorporated by reference to the same extent as if each individual publication or patent application was specifically and individually indicated to be incorporated by reference.

### BACKGROUND

Patients may present with a variety of oral and upper airway conditions. Oral conditions may include, without being limiting in any regard, malocclusions such as Class II and Class III malocclusions, and narrow maxillary arch. Upper airway conditions include, without being limiting in any regard, obstructive sleep apnea (OSA).

OSA is a serious medical condition characterized by complete or partial blockage of the upper airway during sleep. An obstruction may be caused by relaxation of soft tissues and muscles in or around the throat (e.g., the soft palate, back of the tongue, tonsils, uvula, and pharynx) during sleep. OSA episodes may occur multiple times per night, thus disrupting the patient's sleep cycle. People who suffer chronic OSA may experience sleep deprivation, excessive daytime sleepiness, chronic fatigue, headaches, snoring, and hypoxia.

There are a variety of oral and airway conditions for which more effective, more efficient, and more comprehensive treatments solutions are needed.

### SUMMARY OF THE DISCLOSURE

The disclosure herein is related to multi-dimensional skeletal correction that can provide a comprehensive and total multi-dimensional treatment solution to treat (rather than manage) one or more complex oral and/or airway conditions, such as, without limitation, Class II and Class III malocclusions, narrow maxillary arch, and obstructive sleep apnea. In general, these methods and apparatuses may include palatal expansion and mandibular advancment to treat multiple (and in some cases, concurrently treating) skeletal corrections. These methods and apparatuses, including systems and devices, as well as software, hardware and firmware, may be used to treat, rather than simply manage, these complex and potentially interrelated conditions such as (but not limited to) Class II and Class III malocclusions, narrow maxillary arch, and obstructive sleep apnea.

Described herein are methods and apparatuses (e.g., systems, devices, including software, hardware and/or firmware) for generating a skeletal treatment plan for multi-dimensional skeletal correction of a patient. For example, a method of generating a skeletal treatment plan for multi-dimensional skeletal correction of a patient may include: receiving or generating a digital skeletal representation of at least an upper jaw and a lower jaw of a patient; determining, based on the digital representation, if the patient has at least one of: an oral skeletal condition or an airway condition; determining an amount of multi-dimensional skeletal correction between an initial skeletal arrangement and a target skeletal arrangement to treat the at least one condition, the multi-dimensional skeletal correction including: an amount of lateral skeletal correction to an upper jaw, an amount of anterior-posterior (A-P) skeletal correction of one or both of the patient's mandible or maxilla, and an amount of vertical skeletal correction between the mandible and the maxilla, or any combination of the lateral, skeletal and vertical skeletal corrections; determining, based on the determined amount of multi-dimensional skeletal correction to treat the at least one condition, a skeletal treatment plan comprising determining sequential treatment stages to provide the multi-dimensional skeletal correction, wherein the sequential treatment stages comprise a series of wearable pairs of an upper appliance and a lower appliance, that when sequentially worn by the patient, provide the multi-dimensional skeletal correction; and outputting instructions to fabricate the series of wearable pairs of upper appliances and lower appliances.

In general in any of the apparatuses and method described herein, addition to or instead of CBCT, breathing sensors could be used to support/identify the amount of either or both of skeletal expansion or/and mandibular advancement.

The at least one of the oral skeletal condition or the airway condition may comprise obstructive sleep apnea (OSA), and/or one of a Class II bite or a Class III bite. Outputting instructions to fabricate the series of wearable pairs of upper appliances and lower appliances may comprise fabricating the series of pairs of upper appliances and lower appliances. For example, fabricating may comprise using an additive manufacturing process to fabricate the upper appliances. In some examples fabricating comprises using a process that deposits an appliance material layer by layer and cures the appliance material.

Any of the upper and lower appliances herein may be unitary upper appliances and unitary lower appliances, respectively. Any of the upper and lower appliances herein may, however, be non-unitary, such as if components of the appliance are individually 3-D printed and assembled. Unitary appliances herein may be, for example, fabricated using an additive manufacturing process, such as 3-D printing the appliance. Any of these appliances may be 3D printed. Non-limiting examples of the appliances that may be used as part of the methods and apparatuses described herein may include, but are not limited to tongue shields, tongue ribs, tongue crib, palatal expanders, retainers, aligners, etc.

Receiving or generating a digital skeletal representation of at least an upper jaw and a lower jaw of a subject may further comprise receiving or generating a digital representation of a portion of the patient's upper airway. Receiving or generating the digital skeletal representation of at least the upper jaw and the lower jaw of a patient may comprise receiving a cone-beam computed tomography (CBCT) scan. In some examples receiving or generating the digital skeletal representation comprises receiving or generating the digital representation from cone-beam computed tomography (CBCT). For each of the pairs, the upper appliance may include a left tooth engagement region, a right tooth engagement region, a palatal region between the left tooth engagement region and the right tooth engagement region, and an upper block extending from the left or right tooth engagement region, and the lower appliance is configured to be removably worn over teeth in the patient's lower jaw, the lower appliance including a lower block, and over the course of a treatment time for the pair, the upper appliance is sized and shaped to cause lateral skeletal expansion of the upper jaw, and/or the interface between the upper and lower blocks provides anterior-posterior (A-P) skeletal correction between a mandible and a maxilla of the patient.

Over the course of the treatment time for the pair, the upper appliance may be sized and shaped to cause lateral skeletal expansion of the upper jaw and the interface between the upper and lower blocks provides A-P skeletal correction between the mandible and the maxilla. In any of these examples A-P skeletal correction between the mandible and the maxilla may comprise anterior movement of the mandible relative to the maxilla. The lateral skeletal expansion and the anterior movement of the mandible may treat at least one of a Class II bite or OSA. The A-P skeletal correction between the mandible and the maxilla may comprise posterior movement of the mandible relative to the maxilla, optionally to treat a Class III bite. The A-P skeletal correction between the mandible and the maxilla may comprise anterior movement of the maxilla relative to the mandible. In some examples A-P skeletal correction between the mandible and the maxilla comprises posterior movement of the maxilla relative to the mandible.

In any of these methods (or systems configured to perform them) over the course of the treatment time for the pair, the interface between the upper and lower blocks may further provide vertical skeletal expansion between the maxilla and the mandible. The upper and lower blocks may each comprise occlusal and/or buccal blocks. The lower appliance may comprise a shell with a plurality of cavities each configured to receive therein a lower jaw tooth, wherein the lower blocks extend from an occlusal and/or buccal surface of the lower appliance. The treatment plan may comprise at least one epoch of time (e.g., at least one treatment stage) with simultaneous lateral skeletal correction of the upper jaw and A-P skeletal correction. In some examples the treatment plan comprises at least one epoch of time (e.g., at least one treatment stage) with lateral skeletal correction without A-P skeletal correction. The treatment plan may comprise at least one epoch of time (e.g., at least one treatment stage) with A-P skeletal correction without lateral skeletal correction.

As mentioned, also described are systems for performing any of these methods and/or software (e.g., a memory storing computer-program instructions, that, when executed by the one or more processors, perform any of these methods). For example a system may include: one or more processors and a memory coupled to the one or more processors, the memory storing computer-program instructions, that, when executed by the one or more processors, perform a method comprising: receiving or generating a digital skeletal representation of at least an upper jaw and a lower jaw of a patient; determining, based on the digital representation, if the patient has at least one of: an oral skeletal condition or an airway condition; determining an amount of multi-dimensional skeletal correction between an initial skeletal arrangement and a target skeletal arrangement to treat the at least one condition, the multi-dimensional skeletal correction including: an amount of lateral skeletal correction to an upper jaw, an amount of anterior-posterior (A-P) skeletal correction of one or both of the patient's mandible or maxilla, and an amount of vertical skeletal correction between the mandible and the maxilla, or any combination of the lateral, skeletal and vertical skeletal corrections; determining, based on the determined amount of multi-dimensional skeletal correction to treat the at least one condition, a skeletal treatment plan comprising determining sequential treatment stages to provide the multi-dimensional skeletal correction, wherein the sequential treatment stages comprise a series of wearable pairs of an upper lateral expansion appliance and a lower appliance, that when sequentially worn by the patient, provide the multi-dimensional skeletal correction; and outputting instructions to fabricate the series of wearable pairs of upper appliances and lower appliances.

Also described herein are the appliances. For example, described herein are a series of pairs of oral appliances, each pair configured to be sequentially worn by a patient as part of a skeletal treatment plan for multi-dimensional skeletal correction, each pair comprising, for one or more pairs in the series: an upper appliance having: a left tooth engagement region configured to be removably worn over a patient's teeth in a left portion of a patient's upper jaw; a right tooth engagement region configured to be removably worn over the patient's teeth in a right portion of the patient's upper jaw; a palatal region between the left tooth engagement region and the right tooth engagement region; and an upper block extending from the left or right tooth engagement region; and a lower appliance configured to be removably worn over teeth in the patient's lower jaw, the lower appliance including a lower block, wherein, the upper and lower blocks each have at least one surface positioned and shaped to interface with a surface on the other of the upper and lower blocks, and over the course of a treatment time for the pair, the upper appliance is sized and shaped to provide lateral skeletal expansion of the upper jaw and/or the interface between the upper and lower blocks provides anterior-posterior (AP) skeletal correction between a mandible and a maxilla of the patient to at least partially treat the condition.

Over the course of the treatment time for the pair, the palatal region may be sized and shaped to cause lateral skeletal expansion of the upper jaw and the interface between the upper and lower blocks provides A-P skeletal correction between the mandible and the maxilla. A-P skeletal correction between the mandible and the maxilla may comprise anterior movement of the mandible relative to the maxilla. The lateral skeletal expansion and the anterior movement of the mandible may be part of treatment plan for at least one of a Class II bite or obstructive sleep apnea. A-P skeletal correction between the mandible and the maxilla may comprise posterior movement of the mandible relative to the maxilla, optionally to treat a Class III bite. For example, A-P skeletal correction between the mandible and the maxilla may comprise anterior movement of the maxilla relative to the mandible. A-P skeletal correction between the mandible and the maxilla may comprise posterior movement of the maxilla relative to the mandible. Over the course of the treatment time for the pair, the interface between the upper and lower blocks may further provide skeletal vertical expansion between the upper and lower jaw. The upper and lower blocks may each comprise occlusal blocks. The lower appliance may comprise a shell with a plurality of cavities each configured to receive therein a lower jaw tooth, wherein the lower blocks extend from an occlusal and/or buccal surface of the lower appliance. The series of pairs may be configured, at least during a treatment time of one of the pairs, for simultaneous lateral skeletal correction of the upper jaw and A-P skeletal correction. The series of pairs may be configured, at least during a treatment time of one of the pairs, for lateral skeletal correction without A-P skeletal correction. The series of pairs may be configured, at least during a treatment time of one of the pairs, for A-P skeletal correction without lateral skeletal correction. The upper and lower blocks may each comprise an occlusal block. The upper and lower blocks may each comprise a buccal block. The upper appliances may be directly fabricated, optionally using an additive manufacturing process, optionally 3-D printed. The upper appliances may further comprise an anterior region comprising a plurality of teeth receiving structures and/or vertical skeletal correction features.

Also described herein are a series of pairs of oral appliances, each pair configured to be sequentially worn by a patient as part of a skeletal treatment plan for multi-dimensional skeletal correction to treat obstructive sleep apnea (OSA), each pair comprising, for one or more pairs in the series: an upper appliance comprising: a left tooth engagement region configured to be removably worn over a patient's teeth in a left portion of a patient's upper jaw; a right tooth engagement region configured to be removably worn over the patient's teeth in a right portion of the patient's upper jaw; a palatal region between the left tooth engagement region and the right tooth engagement region; and an upper block extending from the left or right tooth engagement region; and a lower appliance configured to be removably worn over teeth in the patient's lower jaw, the lower appliance including a lower block, wherein: the upper and lower blocks each have at least one surface positioned and shaped to interface with a surface on the other of the upper and lower blocks, and for one or more pairs in the series, over the course of a treatment time of the pair, the upper appliance is sized and shaped to cause lateral skeletal expansion of the upper jaw and the interface between the upper and lower blocks provides anterior skeletal correction of a mandible relative to a maxilla of the patient to improve air flow through a patient airway to at least partially provide treatment for obstructive sleep apnea.

Also described herein is a pair of oral appliances, of a series of pairs of oral appliances, the pair configured to be worn by a patient as part of a skeletal treatment plan for multi-dimensional skeletal correction, may include: an upper appliance comprising: a left tooth engagement region configured to be removably worn over a patient's teeth in a left portion of a patient's upper jaw; a right tooth engagement region configured to be removably worn over the patient's teeth in a right portion of the patient's upper jaw; a palatal region between the left tooth engagement region and the right tooth engagement region; and an upper block extending from the left or right tooth engagement region; and a lower appliance configured to be removably worn over teeth in the patient's lower jaw, the lower appliance including a lower block, wherein, the upper and lower blocks each have at least one surface positioned and shaped to interface with a surface on the other of the upper and lower blocks, and, over the course of a treatment time of the pair, the upper appliance is sized and shaped to cause lateral skeletal expansion of the upper jaw and/or the interface between the upper and lower blocks provides anterior-posterior (A-P) skeletal correction of a mandible relative to a maxilla of the patient.

An upper jaw appliance for use as part of a skeletal treatment plan for multi-dimensional skeletal correction, may include: a left tooth engagement region configured to be removably worn over a patient's teeth in a left maxillary portion of a patient's upper jaw; a right tooth engagement region configured to be removably worn over the patient's teeth in a right maxillary portion of the patient's upper jaw; a palatal region between the left tooth engagement region and the right tooth engagement region, the palatal region sized and shaped for lateral skeletal expansion of the upper jaw; and an upper block with at least one surface configured to mate with a lower block of a lower tooth appliance to provide anterior to posterior (A-P) skeletal correction.

Also described herein are methods of designing an upper appliance and a lower appliance for multi-dimensional skeletal correction of a patient, comprising: determining a movement path to move one or more bones from an initial skeletal arrangement to a target skeletal arrangement; determining a force system to produce movement of the one or more bones along the movement path; determining an appliance geometry and/or material composition for a series of pairs of upper appliances and lower appliances to produce the force system; and optionally generating instructions for fabricating the series of pairs of upper and lower appliances, each having an appliance geometry and material composition.

Also described herein are systems comprising: one or more processors; a memory coupled to the one or more processors, the memory storing computer-program instructions, that, when executed by the one or more processors, perform a computer-implemented method comprising: determining a movement path to move one or more bones from an initial skeletal arrangement to a target skeletal arrangement; determining a force system to produce movement of the one or more bones along the movement path; determining an appliance geometry and/or material composition for a series of pairs of upper appliances and lower appliances to produce the force system; and optionally generating instructions for fabricating the series of pairs of upper and lower appliances, each having an appliance geometry and material composition.

The following references are herein incorporated by reference in their entirety for all purposes: U.S. Pat. Nos. 9,844,424; 10,537,406; 10,213,277; 10,912,629; 10,517,701; 10,537,463; 10,588,776; 11,779,437; 11,419,702; 11,737,857; 11,771,531; 11,786,341; 11,793,608; 11,793,667; and 11,801,124; US. Pubs 2021/0169617A1; 2021/0236243A1; 2022/0387141A1; U.S. applications Ser. No. 18/315,454; Ser. No. 18/342,708; and Ser. No. 18,360,125; and U.S. Pat. No. 11,576,754.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIGS. 1A-1C illustrates lateral skeletal correction, anterior and posterior skeletal correction, and vertical bite skeletal correction, respectively, between the maxilla and the mandible.

FIGS. 2A-2B illustrate examples of dental appliances as described herein.

FIG. 3A illustrates an example of a lower appliance.

FIG. 3B illustrates an example of a lower appliance including occlusal blocks.

FIG. 4 is an example of an upper appliances and a series of exemplary lower appliances (which may be part of a pair of upper and lower appliance) configured to provide A-P skeletal movement as part of a skeletal correction treatment during one or more stages.

FIG. 5 illustrates an example of an upper appliance and a lower appliance each having an occlusal block structure.

FIG. 6 illustrates an example of an appliance including an occlusal block structure.

FIG. 7 shows an example of a method for generating or creating a skeletal treatment plan for multi-dimensional skeletal correction of a patient.

FIG. 8 shows a method for designing upper and lower appliances, which may be a pair in a series of upper and lower appliance as part of a skeletal correction plan for multi-dimensional skeletal correction.

FIG. 9 shows an example of a method of fabricating one or more pairs of upper and lower appliances.

FIG. 10 illustrates an example of a multi-dimensional skeletal treatment method.

FIG. 11 schematically illustrates a method that can be part of a skeletal treatment plan.

FIG. 12 schematically illustrates a method that can be part of a skeletal treatment plan.

FIGS. 13 and 14 illustrate examples of one or more scanned images generated using skeletal scanning system.

FIG. 15 illustrates one example of a method or portion of a method of a skeletal treatment plan to treat OSA.

FIG. 16 illustrates one example of a method of training a learning algorithm for post-skeletal correction airway morphology.

FIGS. 17A-17B illustrate an upper airway of a subject without (FIG. 17A) and with (FIG. 17B) mandicular advancement as described herein.

FIG. 18 illustrates an example of an appliance that can be worn on lower teeth as part of any of the skeletal treatment plans described herein.

FIG. 19 is an example of a dental appliance including a palatal expander region as described herein.

FIG. 20 schematically illustrates a skeletal treatment planning system.

### DETAILED DESCRIPTION

The disclosure herein is related to multi-dimensional skeletal correction that can provide a comprehensive and total multi-dimensional treatment solution to treat (rather than manage) one or more complex oral and/or airway conditions, such as, without limitation, Class II and Class III malocclusions, narrow maxillary arch, and obstructive sleep apnea.

The phrase “skeletal correction” as used herein may refer to movement, expansion and/or contraction of one or more skeletal bones and teeth, such as one or more of a maxilla (upper jaw) or mandible (lower jaw) to treat one or more conditions, unlike approaches that temporarily manage a condition. Skeletal correction may be determined based on movement relative to one or more reference points, axes, and/or planes, depending on the type of skeletal correction involved.

The multi-dimensionality of skeletal correction describe herein refers to any combination of lateral skeletal correction to an upper jaw (expansion or contraction), anterior-posterior (“A-P”) skeletal correction of one or both of a subject's mandible or maxilla, and vertical bite skeletal correction between the mandible and the maxilla. For example, the multi-dimensional skeletal correction may be three-dimensional correction and include lateral, A-P and vertical corrections. The multi-dimensional skeletal correction herein may be less than three-dimensional, such as including lateral and A-P corrections; lateral and vertical corrections; or A-P and vertical corrections.

A-P skeletal correction as described herein includes one or more of moving the mandible in the anterior direction, moving the mandible in the posterior direction, moving the maxilla in the anterior direction, and moving the maxilla in the posterior direction. In some treatments, A-P skeletal correction may apply a net anterior (protrusive) force on the patient's mandible. In some treatments, the A-P skeletal correction may apply a net posterior (retrusive) force on the patient's maxilla. In some treatments, A-P skeletal correction may apply a net posterior (retrusive) force on the patient's mandible. In some treatments, A-P skeletal correction may apply a net anterior (protrusive) force on the patient's maxilla.

Lateral skeletal correction may comprise lateral expansion or lateral contraction, and may occur in one or both of the upper jaw or the lower jaw. For example, lateral expansion may comprise upper palate lateral expansion.

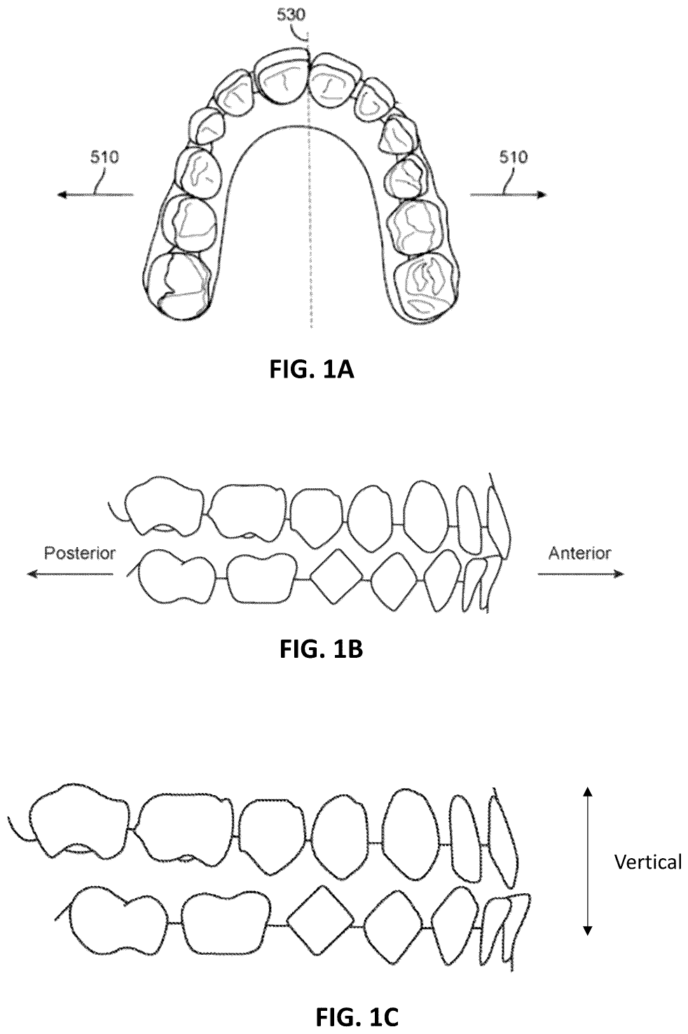

FIG. 1A illustrates a direction of lateral skeletal correction 510 relative to midline 530, which in this case is lateral skeletal expansion of teeth. FIG. 1B illustrates directions of anterior and posterior skeletal correction shown by the arrows. FIG. 1C illustrates directions of vertical bite skeletal correction between the maxilla and the mandible.

The multi-dimensional skeletal corrections herein may treat one or more conditions, optionally which are at least one of an oral skeletal condition or an airway condition. Oral skeletal conditions that may be treated include malocclusions, such as Class II and Class III malocclusions, or narrow maxillary arch. Airway conditions that may be treated include but are not limited to OSA.

The multi-dimensional skeletal corrections described herein are generally part of a skeletal treatment plan for the patient to treat the one or more conditions. The skeletal treatment plan may include sequential treatment stages that together provide a total multi-dimensional skeletal correction. The skeletal treatment plan may include the design or fabrication of and/or wearing of a series of wearable pairs of oral appliances, that when worn sequentially provide the multi-dimensional skeletal correction to treat the one or more conditions. The pairs of wearable oral appliances may each include an intraoral unitary upper lateral expansion appliance and an intraoral lower appliance. The oral appliances described herein may also be referred to as appliances. The unitary upper lateral correction appliances herein may also be referred to as unitary upper appliances or upper appliances. In some examples the unitary upper lateral correction appliances herein may be configured as and referred to as unitary upper lateral expansion appliances.

The multi-dimensional skeletal correction treatments described herein provide treatments and patient outcomes not previously achievable with existing approaches, treatment options for one or more conditions not previously achievable, more efficient treatment options for one or more conditions, more effective treatment options for one or more conditions, and/or better patient outcomes in general following the skeletal treatment.

The multi-dimensional skeletal corrections described herein, as part of a skeletal treatment plan, provide improvements to technology and patient care not previously achievable. For example only, some multi-dimensional skeletal treatment plans described herein may include, between an initial skeletal arrangement to a target skeletal arrangement, lateral skeletal correction of an upper jaw and some A-P skeletal correction between a mandible and a maxilla (optionally but not limited to treating a malocclusion and/or OSA). These multi-dimensional skeletal treatment plans can include planned stages that together facilitate the overall multi-dimensional skeletal correction over the course of the treatment plan, optionally with a unitary upper lateral oral appliance and a lower oral appliance. Some types of skeletal corrections may typically occur over different treatment times, and the treatment plans herein can determine stages that can implement different directions of skeletal correction into a single cohesive skeletal treatment plan. The stages can be carefully controlled and determined to achieve a desired or determined correction during that particular stage, as well as part of the overall multi-dimensional skeletal treatment plan. For example only and without any limitation, a treatment plan may include initiating a first type of skeletal correction (e.g., lateral, A-P, vertical) before a different type of skeletal correction is initiated. In these examples, the stages can be determined to provide the desired sequential correction and yet still provide the overall multi-dimensional skeletal correction over the course of the treatment plan.

Additionally, the upper and lower appliances described herein, which may be a part of a series of upper and lower appliances, provide improvements to oral appliance technology as well as the improvements to treatments and treatment options set forth above. The upper and lower appliances herein can be adapted to be worn during the different treatment stages to provide the carefully controlled and more comprehensive multi-dimensional treatment options described herein, both during an individual stage, as well as over the course of the treatment plan.

An exemplary but non limiting advantage of some multi-dimensional skeletal treatments herein is the ability to provide multi-dimensional correction during a single treatment plan, which may not have been previously achievable. For example only, appliances and approaches herein can, over a planned treatment with a series of digitally designed series of appliances, provide both lateral and A-P skeletal correction to treat a variety of conditions.

The multi-dimensional correction may also improve existing treatments for one or more conditions. For example only, mandibular advancement can now be performed with palatal expansion in the same treatment plan for a total multi-dimensional treatment solution, which may also be able to improve the mandibular advancement treatment.

Additionally, the multi-dimensional correction treatment provided herein can treat multiple conditions that typically have different treatment times, different treatment planning, and now allow them to be treated as part of the same treatment plan. For example only, multi-dimensional correction can combine treatments such as palatal expansion and mandibular advancement, which typically have different treatment times, with palatal expansion typically (but not always) having faster treatment times. The multi-dimensional corrections herein may integrate treatments that typically have different treatment times and/or have not been able to be treated together for a comprehensive total multi-dimensional treatment solution.

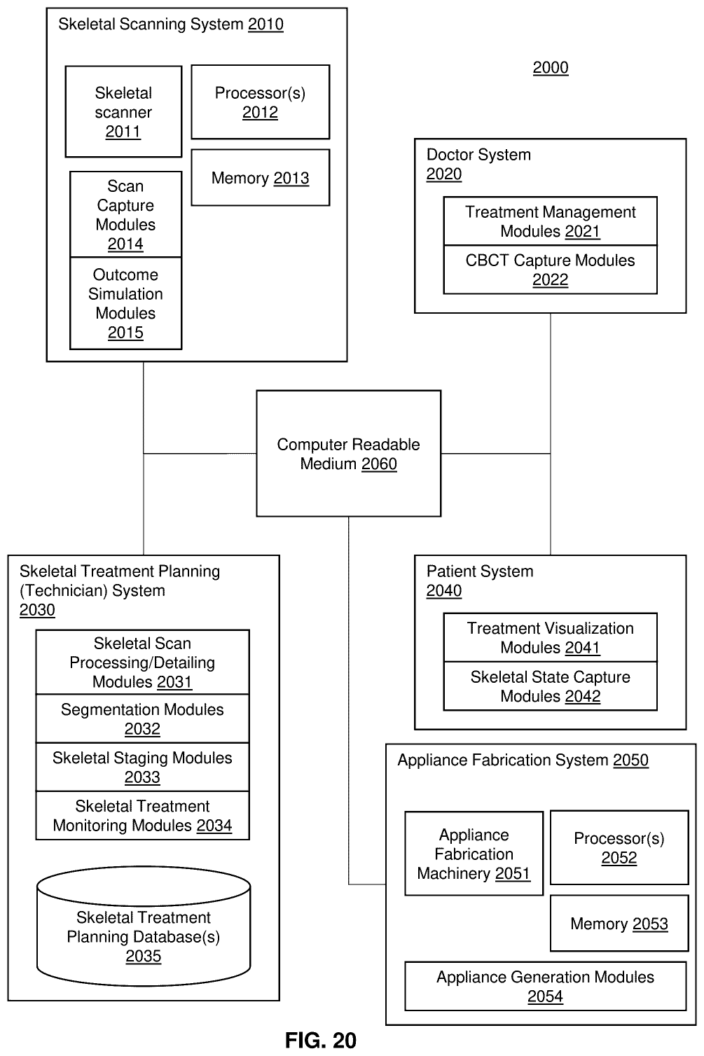

The skeletal treatment plans described herein can be determined as part of the skeletal treatment planning system 2030, as shown in FIG. 20. For example, the skeletal treatment stages determined herein may be determined as part of the skeletal staging modules 2033, as shown in FIG. 20.

The series of pairs of wearable oral appliances, when worn sequentially, are configured to provide some combination of lateral skeletal correction to an upper jaw, A-P skeletal correction to one or both of the patient's mandible or maxilla, and vertical skeletal correction between the mandible and the maxilla.

Upper appliances, as described further herein may include structures that, when engaged with a person's dentition, achieve one or more of lateral skeletal correction, A-P correction, and/or vertical control of anterior teeth. In some implementations, upper appliances can include a tooth engagement region for engaging at least a portion of the teeth in the patient's upper jaw. In some implementations, a tooth engagement region of an upper appliance engages a person's molars, a person's anterior teeth, or some combination thereof. Upper appliances, as disclosed herein, may include a palatal region that engages and provides a lateral force to a person's palate. In some implementations, a palatal region extends between a pair of tooth engagement region.

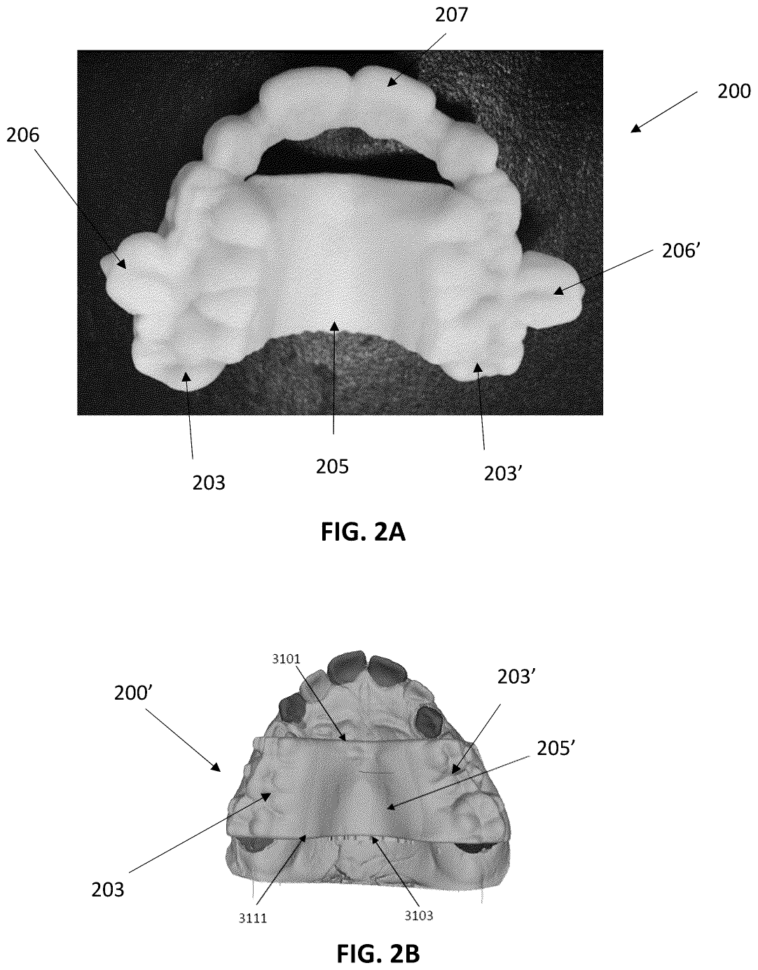

For example, FIG. 2A shows an example of a unitary upper appliance 200, which in alternative implementations may not be unitary. In the example of FIG. 2A, the unitary upper appliance 200 includes a pair of tooth engagement regions 203 and 203′, a palatal region 205, blocks 206 and 206′, and vertical control region 207. The tooth engagement regions 203 and 203′ can be shaped to receive and engage at least a portion of a person's dentition. In this example, the tooth engagement regions 203 and 203′ receive and engage posterior teeth (e.g., molars or pre-molars) on opposite sides of a person's dentition. The tooth engagement regions 203 and 203′ can be connected through the palatal region 205. In this example, the tooth engagement regions 203 and 203′ include blocks 206 and 206′. The blocks 206 and 206′ can extend from one of the tooth engagement regions 203 and 203′, as shown. Upper blocks 206 and 206′ each have at least one surface positioned and shaped to interface with a surface on a lower block of a lower oral appliance, described in more detail below. The blocks 206 and 206′ can be shaped to engage with opposing blocks (not shown) on a lower appliance (optionally a unitary lower appliance) that opposes the unitary upper appliance 200. When blocks 206 and 206′ engage opposing blocks on a lower appliance, the blocks 206 and 206′, together with the opposing blocks, can exert forces to a person's jaws and skeleton that achieve A-P correction. For instance, the blocks 206 and 206′, together with the opposing blocks on a lower appliance, can exert forces that cause a person's mandible to advance and/or retract. In various implementations, the blocks 206 and 206′ together with the opposing blocks on a lower appliance, cause displacement in the A-P direction based on the skeletal correction.

In various implementations, the amount(s) of A-P force exerted by the blocks 206 and 206′ together with the opposing blocks on a lower appliance are programmed by a digital treatment plan. As an example, treatment planning software (described further herein) can set the size, material properties (e.g., density, etc.), and/or other properties of the blocks 206 and 206′ at various stages of treatment to exert forces to achieve desired A-P correction. As another example, the size, material properties, and/or other properties of the blocks 206 and 206′ can be set to provide a constant, variable, or other amount of force through the course of a treatment plan to achieve desired A-P correction.

The palatal region 205 can include a region that extends across a person's palate. The palatal region 205 can be shaped to engage and exert lateral forces on a person's palate. For example, the palatal region 205 can include a first surface shaped to abut and/or engage the surface of a person's palate. Portions of the palatal region 205 can be shaped to engage with a person's palate. As an example, posterior portions (e.g., those corresponding to molar, pre-molar, etc. teeth) of the palatal region 205 can be shaped to exert engagement and/or retention forces on corresponding teeth to keep the palatal region 205 retained and/or engaged in the person's palate. In various implementations, the upper appliance 200 may exert 2 N-10 N of retention force on, for example, attachments.

As noted herein, the palatal region 205 can exert lateral forces on a person's palate. In some implementations, the material of the palatal region 205 has a property that exerts lateral forces on a person's palate. As an example, the palatal region 205 is formed of a material having a stiffness matrix such that, when the palatal region 205 is engaged with a person's palate, the palatal region 205 exerts lateral expansion forces on the person's palate.

In various implementations, the amount(s) of force exerted by the palatal region 205 arc programmed by a digital treatment plan. As an example, treatment planning software (described further herein) can set the size (width, length, geometry of region facing palate, etc.), material properties (e.g., stiffness, density, etc.), and/or other properties of the palatal region 205 at various stages of treatment to exert lateral forces. As another example, the size, material properties, and/or other properties of the palatal region 205 can be set to provide constant, variable, or other amount(s) of force through the course of a treatment plan to achieve desired lateral correction. In various implementations, the palatal region 205 can exert, e.g., 20 N-40 N of lateral force.

The shape of the palatal region 205 can be customized to a person's palate using one or more design parameters and/or techniques, e.g., using the techniques of U.S. patent application Ser. No. 15/831,262 (issued as U.S. Pat. 10,993,783), entitled “Methods and Apparatuses for Customizing a Rapid Palatal Expander,” to Align Technology, Inc. In some implementations, the shape of the palatal region 205 is designed using constraints that limit the geometries of palatal regions that can be manufactured and/or are effective to engage/retain and/or provide lateral forces. The palatal region 205 can engage with orthodontic attachments (not shown in FIG. 2A) on posterior teeth. An “orthodontic attachment,” as used herein, can include a structure bonded or otherwise placed on a person's dentition that, when engaged by a corresponding structure in a dental appliance, causes application of forces (retention, tooth movement, lateral expansion, etc. forces) to the person's dentition. In some implementations, the palatal region 205, through engagement with orthodontic attachments on posterior teeth, exert forces that retain and/or engage the unitary upper appliance 200 to a person's teeth. The palatal region 205, through engagement with orthodontic attachments on posterior teeth, can also cause lateral forces to be directed to a person's teeth. In this example, the unitary upper appliance may also include a pair of attachment regions (not labeled) that may each enclose an attachment connector that is bonded to the patient's teeth, e.g., on either side of the appliance (on a buccal side of the patient's teeth). The attachment connector (also referred to herein as a connector, pin, attachment, or the like) may be secured to the teeth in a position that allows it to couple (e.g., removably couple) to the attachment region(s) on the upper appliance. An attachment connector may be bonded (glued, etc.) to the teeth. In the appliance shown in FIG. 2A, the palatal region has a convex upper surface that is opposite the concave lower surface. The lower surface is a lingual (tongue-facing) surface; the upper surface faces the palate. Features of the devices and methods described in U.S. Pat. No. 11,576,754, which is incorporated by reference herein in its entirety for all purposes, may be incorporated into the unitary upper skeletal corrective appliances herein, including unitary upper appliance 200.

The vertical control region 207 can include a region shaped to move corresponding teeth along or relative to a sagittal plane. In the example of FIG. 2A, the vertical control region 207 includes a region shaped to receive and provide intrusion and/or extrusion forces to a person's anterior teeth. The vertical control region 207 can, e.g., be shaped to receive and provide intrusion and/or extrusion forces to a person's central incisors, lateral incisors, canines, or some combination thereof. The vertical control region 207 can include a plurality of tooth-receiving cavities, which, through the course of a treatment plan, exert intrusion and/or extrusion forces to a person's anterior teeth through a series of programmed displacements and/or force application structures (e.g., power-ridges, dimples, bumps, wells to interface with orthodontic attachments, etc.).

In various implementations, the amount(s) of force exerted by the vertical control region 207 are programmed by a digital treatment plan. As an example, treatment planning software (described further herein) can set shapes, displacements, attributes of force control structures, and/or other attributes of the vertical control region 207 at various stages of treatment to vertically control intrusion and/or extrusion of anterior teeth. As another example, the size, material properties, and/or other properties of the vertical control region 207 can be set to provide constant, variable, or other amount(s) of intrusion/extrusion forces through the course of a treatment plan to achieve desired vertical control. In various implementations, the vertical control region 207 can exert, e.g., 1 N-7 N of intrusion and/or extrusion forces on anterior teeth.

FIG. 2B illustrates an example of a position of unitary upper appliance 200′ (upper blocks not shown) with first tooth engagement region 203 removably worn over representations of teeth in a first portion of an upper jaw, and second tooth engagement region 203′ removably worn over representations of teeth in a second portion of the upper jaw, and a palatal region 205′. In FIG. 2B, anterior margin 3101 falls between the premolar and molar (T4 and T3 on the right side, between T13 and T14 on the left side). The posterior margin 3103 is also shown on the lingual-facing side 3111 of the appliance.

The upper appliances described herein can be worn in a series of upper appliances as part of a skeletal treatment plan for multi-dimensional skeletal correction. The upper appliances may be configured to apply force within the patient's mouth to expand the patient's maxilla as part of a skeletal treatment plan. In particular, described herein are apparatuses, e.g., devices and/or systems, including individual upper appliances and/or a series or sequence of upper appliances, and methods of making and using such appliances. The methods and apparatuses described herein include methods and apparatuses (e.g., systems, including software, hardware and/or firmware) for planning and generating a sequence of unitary upper appliances that may move the patient's left and right maxillary halves as part of a multi-dimensional skeletal correction plan. These methods may limit the force and/or rate of movement delivered by each upper appliance in a sequence of upper appliances. Any of these methods and upper appliances may optionally also account for translation and tipping of the left and right maxillary halves as treatment progresses, and may also optionally account for tipping of the teeth, and changes in the shape (morphology) of the palate as treatment progresses. Designing and determining a geometry and/or material for the upper appliances herein can be part of the skeletal staging module 2033, shown in FIG. 20.

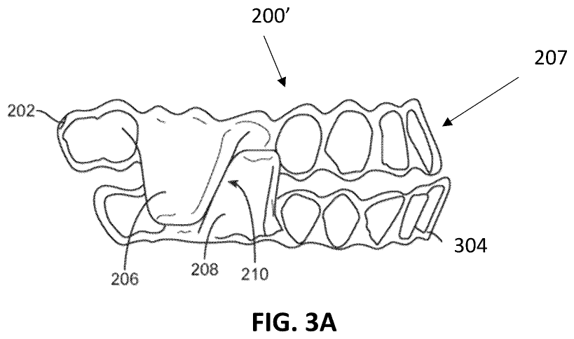

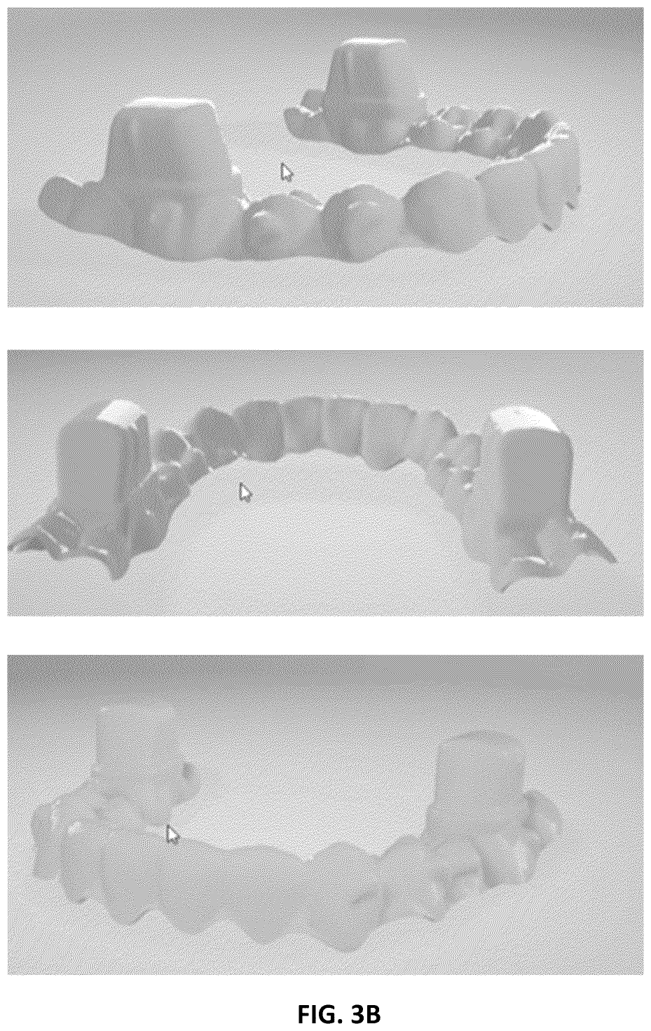

For example only, FIG. 3A shows an example of a lower appliance 304 including a lower block or protrusion 208, which in this example is a lower buccal block. FIG. 3A also shows a representative upper lateral correction appliance 200′ including at least one upper block or protrusion 206, which may be the same as or similar to upper appliance 200 shown in FIG. 2A, the entire disclosure of which is incorporated into the disclosure of FIG. 3A. In this example, upper block 206 is an upper buccal block. Blocks 206 and 208 each have at least one surface positioned and shaped to interface with a surface on the other of the upper and lower blocks. In some skeletal correction treatments, upper block 206 engages lower block 208 to cause anterior movement of the mandible relative to the maxilla when worn. In some treatments, upper block 206 engages lower block 208 to retract the maxilla in the posterior direction relative to the mandible when worn. Since upper block 206 is positioned posteriorly relative to lower block 208 in this example, engagement of the upper and lower blocks 206, 208 produces relative A-P forces that cause relative A-P movement between the maxilla and mandible, which may be part of any of the skeletal treatment plans herein that include multi-dimensional skeletal correction.

In FIG. 3A, upper block 206 is depicted as a protrusion extending downwards towards the lower jaw, and the lower block 208 is depicted as a protrusion extending upwards towards the upper jaw, such that the two protrusions contact and engage each other along an engagement region 210 when the upper and lower appliances 202, 304 are brought together. For instance, the engagement region 210 can include a surface of the upper block (e.g., an anterior surface) that engages a corresponding engagement surface of the lower block (e.g., a posterior surface). Optionally, the upper and lower blocks can have complementary shapes that mate with each other to improve the stability of engagement. In the embodiment of FIG. 3A, the upper and lower blocks 206, 208 are depicted as being located on the buccal surfaces of the upper and lower appliances 202, 204, respectively. In alternative embodiments, the blocks 206, 208 can be positioned on other surfaces of the appliances 202, 204, such as on the lingual surfaces or occlusal surfaces, some examples of which are described below. Additionally, although FIG. 3A depicts a single pair of blocks 206, 208, it will be appreciated that the upper and lower appliances 200, 304 can be modified as desired to include multiple pairs of upper and lower blocks located at different portions of the appliances 200, 304 (e.g., a first pair located on the left side of the appliances 200, 304 and a second pair located on the right side of the appliances 200, 304).

FIG. 3B illustrates three views of an exemplary alternative lower appliance (upper appliance not shown) with blocks that is configured for mandibular advancement and vertical control.

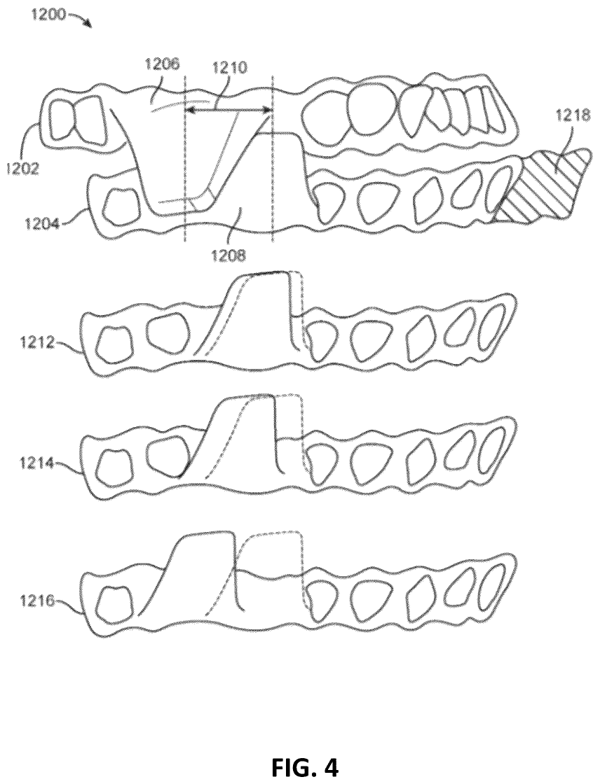

The upper and lower blocks herein are sized and positioned relative to each other to engage one another when the upper and lower appliances are brought together (e.g., when the patient's jaws are closed) to cause relative A-P movement between the mandible and maxilla, during one or more stages of the treatment plan. FIG. 4 illustrates a representation 1200 of a unitary upper lateral corrective appliance and a lower appliance (part of a pair of upper and lower appliance) configured to interface and provide A-P skeletal movement as part of a skeletal correction treatment during one or more stages. As shown in FIG. 4, the degree of mandible anterior movement can be controlled by relative positioning of the upper and lower blocks 1206, 1208 along the upper and lower appliances 1202, 1204 and/or the centerline-to-centerline distance 1210 between the blocks 1206, 1208. In some embodiments, the degree of mandible anterior movement can be determined by the positioning of the upper and lower blocks 1206, 1208 on their respective arches. For a given relative jaw position, the lower block 1208 can be placed more posteriorly in order to increase the mandible anterior movement. Accordingly, the positioning of the upper block 1206 and/or the lower block 1208 may be varied in order to achieve a desired amount of jaw A-P movement. For example, in the depiction of FIG. 4, the lower appliances 1204, 1212, 1214, 1216 each have a respective block that is located at a different position along the A-P axis of the appliance. Each lower appliance 1204, 1212, 1214, 1216 can produce a different amount of anterior mandible movement when worn with upper appliance 1202. The appliances 1204, 1212, 1214, and 1216 can be configured to produce increasing amounts of anterior mandible movement up to a maximum or targeted amount of anterior movement 1218.

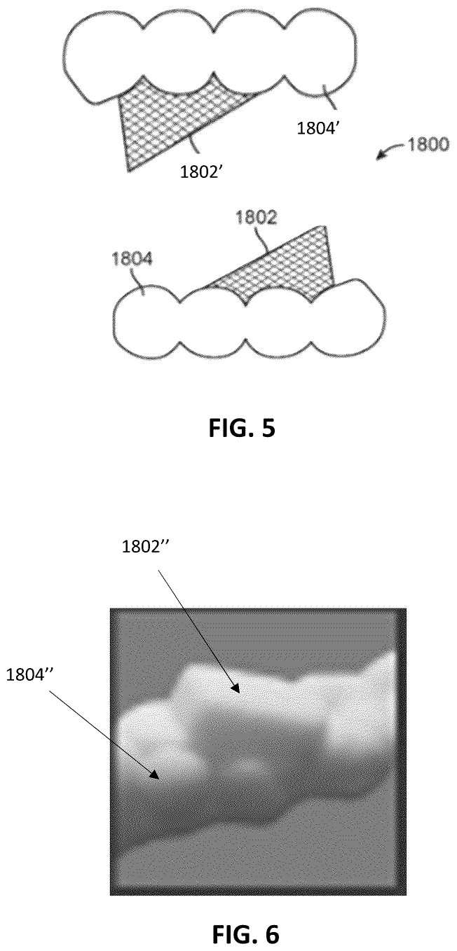

The upper and lower skeletal correction appliances may include blocks or protrusions other than buccal blocks. For example, FIG. 5 illustrates upper and lower appliances (or system) 1800, each with an integrally formed occlusal block structure 1802, 1802′ on an occlusal surface of the corresponding upper or lower appliance. The geometry and positioning of the occlusal structures 1802, 1802′ can be configured according to the desired A-P skeletal correction and/or lateral skeletal correction as part of the multi-dimensional skeletal correction. For example, the occlusal structures 1802, 1802′ can be sized, shaped and positioned to serve as a twin block, occlusal block, bite ramp, or advancement structure. Occlusal structures 1802, 1802′ are each shaped to engage one another in order to provide the desired movement along A-P direction and/or a lateral direction. Optionally, the occlusal structures 1802, 1802′ can includes features matching the features of the patient's occlusal surfaces, e.g., occlusal features of the opposing arch. In some embodiments, the built-in occlusal structure 1802 is formed from a different material than the shell lower or upper appliance using a direct fabrication process. For example, one or both of occlusal structures 1802, 1802′ can be formed from a stiffer material than the material of the appliance 1804, 1804′ in order to provide improved durability against bruxing and/or to provide the desired forces as part of the skeletal treatment plan. FIG. 6 shows another example of a portion of an appliance 1804″ having an occlusal structure 1802″.

The lower appliances described herein may be configured to be removably worn over teeth in the patient's lower jaw. The lower appliances herein include at least one lower block having at least one surface positioned and shaped to interface with a surface on an upper block of an upper appliance, examples of which are provided herein. As part of a skeletal treatment plan for multi-dimensional skeletal correction (e.g., determined as part of skeletal treatment planning system 2030 in FIG. 20), an interaction between upper and lower blocks may provide anterior-posterior (A-P) skeletal correction between a mandible and a maxilla of the patient to at least partially treat at least one an oral skeletal condition or an airway condition, optionally during one or more stages of the plan.

As an example, A-P skeletal correction of one or both of the patient's mandible or maxilla may occur over one or more stages as part of a skeletal treatment plan that includes treating a malocclusion, such as a Class II malocclusion or a Class III malocclusion. For Class II malocclusions, the skeletal correction may include relative anterior correction of the mandible (relative to the maxilla). For Class III malocclusions, the skeletal correction may include relative posterior correction of the mandible (relative to the maxilla).

As described herein, the upper and lower appliances described herein may each include one or more types of blocks or protrusions that when interfaced with blocks on the other of the upper or lower appliance cause A-P forces and relative A-P movement and/or lateral forces between the maxilla and the mandible during one or more treatment stages. The blocks (or protrusion or other similar structures) as described herein may be buccal blocks, occlusal blocks, or other types of protrusions that are sized, shaped and positioned to interface with another structure to provide one or more desired forces in one or more direction and at one or more stages of a multi-dimensional skeletal correction plan. Any of the blocks or protrusions described herein optionally may be reinforced or printed, for example. Any of the blocks or protrusions described herein may optionally be formed by additive manufacturing, such as by being printed, for example. Any of the blocks or protrusions described herein may optionally be unitarily formed with at least a portion of the corresponding upper or lower appliance, such as part of an additive manufacturing process (e.g., 3-D printing). Any one or more blocs described herein may be modular (e.g., formed from a component different than a base material of an upper or lower appliance), and optionally coupled to the corresponding upper or lower appliance. Other manufacturing steps or processes for forming blocks may be set forth herein. Materials for any of the blocks described herein as described herein.

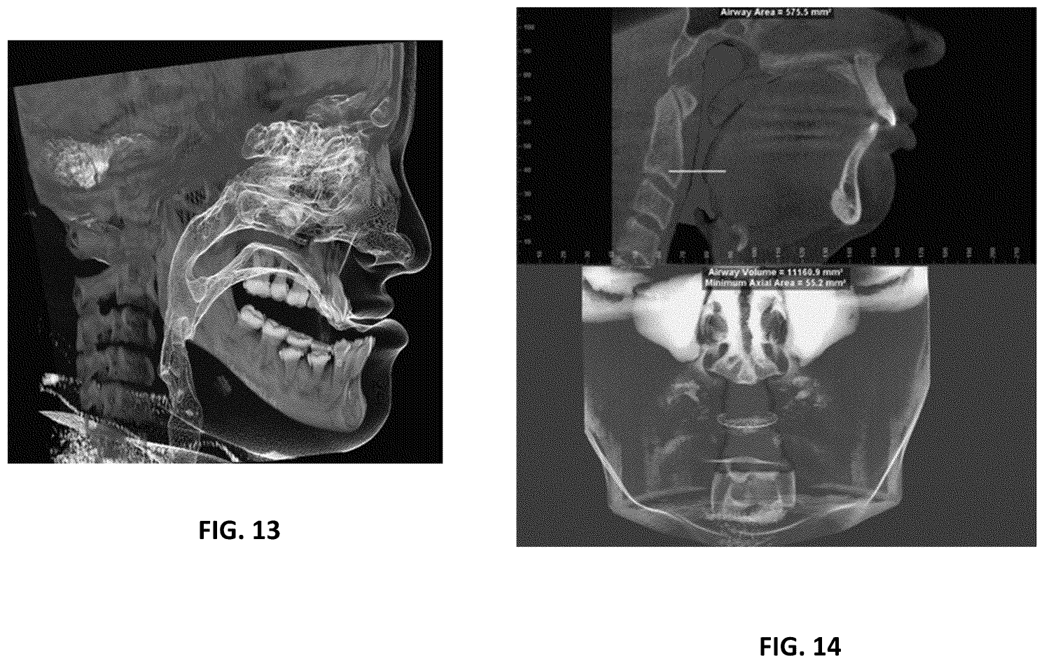

As noted herein, upper and lower appliances can form a series of dental appliances that achieve multi-dimensional skeletal correction through the course of a treatment plan. In reference to the example of FIG. 13 one or more craniofacial images of a person may be generated using one or more input modalities, e.g., intraoral scans, CBCT, x-ray, 2D photos, sensor data, etc. The images may be segmented into a 3D virtual model that depicts a person's craniofacial system having anatomical structures like dentition, maxilla, mandible, and vertebrae. In some implementations, anatomical structures are identified and/or classified with items like labels for individual and/or groups of teeth and/or skeletal elements. The 3D virtual model may be evaluated for anatomical attributes, skeletal issues, and/or proposed corrections. Evaluation can occur by a treatment professional or technician in some implementations. In various implementations, automated agents, without human intervention, may undertake evaluation of a 3D virtual model of a person's craniofacial system for anatomical attributes, skeletal issues and/or proposed corrections. As examples, a person and/or automated agents can look at a 3D virtual model of a person's craniofacial system and evaluate: (a) potential malocclusions, (b) properties of an airway through the craniofacial system, (c) positioning and/or alignment of vertebrae, (d) positioning of maxilla relative to mandible, (c) positioning and/or orientation of anterior teeth in the vertical (e.g., sagittal) and/or other plane, (f) etc., (g) or some combination thereof. A person and/or automated agents may further identify potential skeletal issues using anatomical attributes on a 3D virtual model. For example, identification of airway width, issues related to OSA, underbite, overbite, cross-bite, Class II malocclusions, Class III malocclusions, issues which require lateral expansion, A-P correction, and/or intrusion/extrusion, or some combination thereof, can be identified on a 3D virtual model.

A person and/or automated agent(s) without human intervention can also identify one or more target skeletal arrangements to treat potential skeletal issues using the 3D virtual model or some manipulation thereof. As an example, a target arrangement and a series of intermediate arrangements of a patient's dentition can be identified to treat one or more malocclusions of the dentition. As additional examples, a person and/or automated agent(s) can identify factors to achieve multi-dimensional skeletal correction, e.g.: how much to widen an airway, how much A-P correction would correct positioning and/or alignment of vertebrae, positioning of maxilla relative to mandible, positioning and/or orientation of anterior teeth in the vertical (e.g., sagittal) and/or other plane, or some combination thereof. A person and/or automated agent(s) can further identify one or more intermediate skeletal arrangements that can be implemented in stages to achieve multi-dimensional skeletal correction.

In some implementations, a person and/or automated agent(s) can compare various, possibly competing, factors to achieve stages of multi-dimensional skeletal correction. For instance, a person and/or automated agent(s) without human intervention can implement a skeletal force and/or displacement system that uses lateral correction against A-P correction to treat one or more specific skeletal conditions.

In various implementations, one or more skeletal correction appliances to achieve a skeletal force and/or displacement system that balances lateral correction against A-P correction are designed.

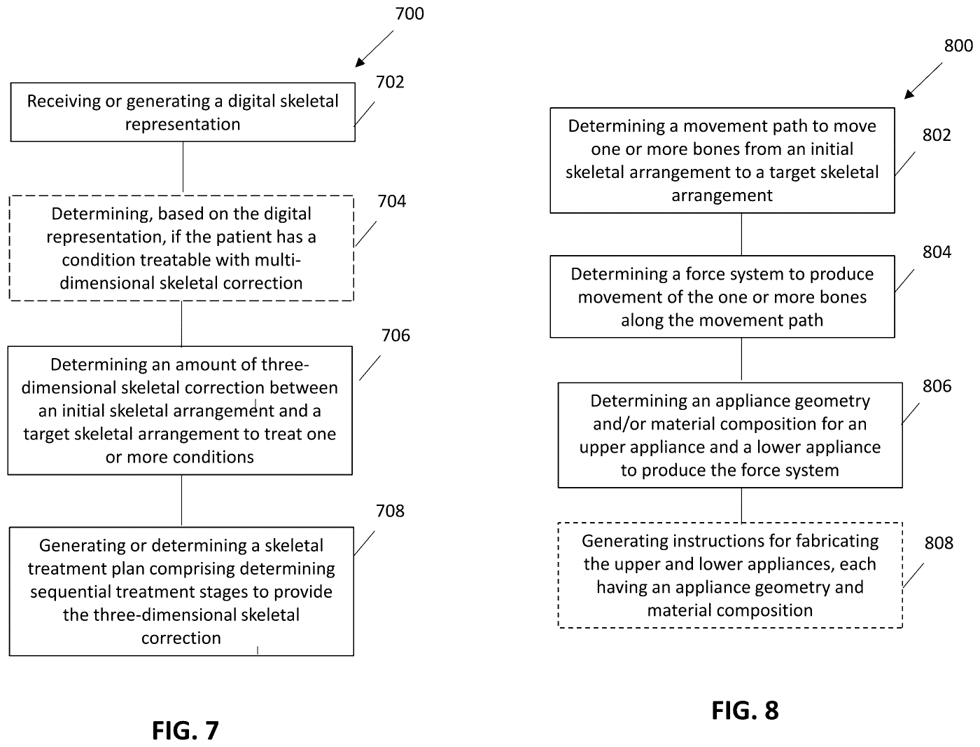

The disclosure herein includes methods of generating skeletal treatment plans, which may occur with or in one or more components of environment 2000 in FIG. 20. FIG. 7 illustrates an example of a method 700 for generating or creating a skeletal treatment plan for multi-dimensional skeletal correction of a patient.

Step 702 comprises receiving or generating a digital skeletal representation of at least an upper jaw and a lower jaw of a patient, optionally also an upper airway of the patient, which may occur in use with skeletal scanning system 2010 in FIG. 20. Receiving or generating a digital skeletal representation of at least an upper jaw and a lower jaw of a patient may include utilizing one or more of x-ray imaging, tomographic imaging, sonographic imaging, cone-beam computed tomography (CBCT), or other techniques for obtaining information about the position and structure of upper and lower jaws and optionally important tissue. Receiving or generating a digital skeletal representation of at least an upper jaw and a lower jaw of a subject may further comprise receiving or generating a digital representation of a portion of the patient's upper airway, which may comprise a digital representation from cone-beam computed tomography (CBCT). Receiving or generating a digital skeletal representation of at least an upper jaw and a lower jaw of a patient may optionally occur as part of skeletal treatment planning system 2020 in FIG. 20, which may comprise generating a skeletal digital model (e.g., a 3D skeletal digital model) based on the skeletal scans obtained using skeletal scanning system 2010 in FIG. 20.

Optional Step 704 comprises determining, based on the digital representation (optionally a model generated in skeletal treatment planning system 2030 in FIG. 20), if the patient has at least one of an oral skeletal condition or an airway condition. An oral skeletal condition may include a malocclusion, such as a Class II or Class III malocclusion. An airway condition may include at least a partial block of an upper airway, which may be determined to be obstructive sleep apnea (OSA). The subject may have more than one condition treatable by the multi-dimensional skeletal corrections described herein.

Step 706 includes determining an amount of multi-dimensional skeletal correction between an initial skeletal arrangement and a target skeletal arrangement to treat the at least one condition. The multi-dimensional skeletal correction may include some combination of an amount of lateral skeletal correction to an upper jaw, an amount of anterior-posterior (AP) skeletal correction of one or both of the patient's mandible or maxilla, and an amount of vertical skeletal correction between the mandible and the maxilla. The initial skeletal arrangement may be determined based on the received or generated digital skeletal representation, which is optionally a digital model generated or created with skeletal treatment planning system 2030 in FIG. 20. Step 706 may occur at least partially in or with skeletal treatment planning system 2030 in FIG. 20.

Step 708 includes, based on the determined amount of multi-dimensional skeletal correction to treat the at least one condition, generating a skeletal treatment plan comprising determining sequential treatment stages to provide the multi-dimensional skeletal correction. The sequential treatment stages may comprise determining a series of wearable pairs of an upper appliance and a lower appliance, that when sequentially worn by the patient, provide the multi-dimensional skeletal correction. Step 708 may be performed with skeletal treatment planning system 2030 in FIG. 20, such as within the skeletal staging modules 2033 in FIG. 20.

Method 700 also optionally, includes, at a time subsequent to generating the skeletal treatment plan, generating and outputting instructions for fabrication the upper and lower appliances having the respective appliance geometry and material composition. The instructions may be configured to control a fabrication system or device (or other particular machine) in order to produce the appliance with the specified appliance geometry and material composition. In some embodiments, the instructions are configured for manufacturing the appliance using direct fabrication (e.g., stereolithography, selective laser sintering, fused deposition modeling, 3D printing, continuous direct fabrication, multi-material direct fabrication, layer-by-layer printing, etc.). Optionally, the instructions may be configured to cause a fabrication machine to directly fabricate the appliance with teeth receiving cavities. In alternative embodiments, the instructions may be configured for indirect fabrication of the appliance, e.g., by thermoforming. Additional fabrication examples are provided below.

The instruction for fabrication the upper appliance may be different than the instructions for fabricating the lower appliance. For example, the instructions for fabricating the upper appliance may be configured for manufacturing the appliance using direct fabrication, and the instructions for fabricating the lower appliance may be configured for indirect fabrication of the appliance (e.g., thermoforming).

For each of the pairs, the upper appliance may comprise a left tooth engagement region, a right tooth engagement region, a palatal region between the left tooth engagement region and the right tooth engagement region, and an upper block extending from the left or right tooth engagement region. For each of the pairs, the lower appliance may be configured to be removably worn over teeth in the patient's lower jaw, the lower appliance including a lower block. For each of the pairs, and over the stage for the pair, the upper appliance is sized and shaped to cause lateral skeletal expansion of the upper jaw, and/or the interface between the upper and lower blocks provides A-P skeletal correction between a mandible and a maxilla of the patient.

The disclosure herein includes methods of designing upper and lower appliances described herein, which may be performed at least partially with skeletal treatment planning system 2030 in FIG. 20. FIG. 8 illustrates a method 800 for designing upper and lower appliances, which may be a pair in a series of upper and lower appliance as part of a skeletal correction plan for multi-dimensional skeletal correction. A series of pairs of upper and lower appliances may be designed according to the exemplary steps in method 800.

Step 802 illustrates determining a movement path to move one or more bones from an initial skeletal arrangement to a target skeletal arrangement. The initial skeletal arrangement may be based on a digital skeletal representation of at least an upper jaw and a lower jaw of a patient that may include utilizing one or more of x-ray imaging, tomographic imaging, sonographic imaging, cone-beam computed tomography (CBCT), or other techniques for obtaining information about the position and structure of upper and lower jaws and/or other tissue. The digital skeletal representation may comprise a digital skeletal model (optionally one or more 3-D models) generated as part of the skeletal scan processing/detailing modules 2031 in FIG. 20 based on the scanned images received from skeletal scanning system 2010 in FIG. 20. Optionally, the initial skeletal arrangement is processed to segment the bone (e.g., upper jaw, lower jaw, and or teeth) and/or other tissue from each other, which may occur with segmentation modules 2032 in FIG. 20. For example, data structures that digitally represent an upper jaw tissue, lower jaw tissue, one or more teeth and/or other tissue proximate an upper airway can be produced.

A target skeletal arrangement of one or more bones and/or teeth (e.g., a desired and intended end result of skeletal correction treatment) can be received from a clinician in the form of a prescription and/or can be extrapolated computationally from a clinical prescription. With a specification of the desired final skeletal arrangement and a digital representation (e.g., a 3-D model) of the target skeletal arrangement, the final relative skeletal positions can be specified to form a complete model of the skeletal arrangement at the desired end of treatment.

Having both an initial skeletal arrangement of the upper and law jaw and a target skeletal arrangement of the upper and lower jaw, a movement path can be defined for the multi-dimensional motion of the one or more bones. In some embodiments, the movement paths are configured to move the one or more bones in the quickest fashion and/or the most optimal fashion to achieve the target skeletal arrangement. The paths may optionally be segmented, and the segments may be calculated so that each bone motion within a segment stays within one or more threshold limits. In this way, the end points of each path segment can constitute a clinically viable skeletal movement, and the aggregate of segment end points can constitute a clinically viable sequence of skeletal movement.

Step 804 includes determining a force system to produce movement of the one or more bones along the movement path. A force system can include one or more forces and/or one or more torques. Different force systems may result in different types of bone movement, such as one or more of lateral movement, anterior movement, posterior movement, vertical movement. Biomechanical principles, modeling techniques, force calculation/measurement techniques, and the like, including knowledge and approaches commonly used in skeletal correction, may be used to determine the appropriate force system to be applied to one or more bones to accomplish the multi-dimensional movement. In determining the force system to be applied, sources may be considered including literature, force systems determined by experimentation or virtual modeling, computer-based modeling, clinical experience, minimization of unwanted forces, etc.

Determination of the force system may be performed in a variety of ways. For example, in some embodiments, the force system is determined on a patient-by-patient basis, e.g., using patient-specific data. Alternatively or in combination, the force system can be determined based on a generalized model of skeletal movement (e.g., based on experimentation, modeling, clinical data, etc.), such that patient-specific data is not necessarily used. In some embodiments, determination of a force system involves calculating specific force values to be applied to one or more bones (optionally indirectly by forces applies on one or more teeth) to produce a particular skeletal movement. Alternatively, determination of a force system can be performed at a high level without calculating specific force values for the bones and/or teeth.

As will be described in greater detail below, the shape of the upper appliance (e.g., an expander), and therefore the load (e.g., force) applied by the appliance when worn, may be controlled and selected during the planning process. Designing an accurate and effective series of upper appliances should ideally accurately model the palatal expansion to include both lateral translation (e.g., in an xy plane) and tipping (e.g., rotational translation) of the right and left maxillary halves, and optionally include translation of one or more of the teeth, including tipping of the teeth due to the forces applied by the upper appliance. In addition, the upper appliances may also be digitally modeled, including modeling both the shape (dimensions, including thickness, curvature, attachment points, etc.) and the material(s) used. Thus, the upper appliances in a series of upper appliances may be accurately and in some cases automatically, configured so that they achieve the desired palatal expansion within predetermined (or user/physician/technician) adjustable parameters such applied expansion force (e.g., between x and y N, less than y N, etc., where x is about 5, 6, 7, 8, 9, 10. 15, 20, 25, 30, 35, 40, 45, 50, 60, 70, etc. and y is about 10, 20, 30, 40, 50, 60, 70, 80, 90, 100, 110, 120, etc. and is less than x), the location of applied forces in the patient's mouth (e.g., upper lateral portion of the molars, mid-lateral portion of the molar, lower lateral portion of the molars, gingiva, palate, etc.) and/or portions of the patient's mouth to avoid contact (e.g., gingiva, palate, mid-palate, lateral palate, etc.).

Step 806 includes determining an appliance geometry and/or material composition for each upper and lower appliance configured to produce the force system. The upper and lower appliances can be any embodiment of the appliances described herein, such as an appliance having variable localized properties, integrally formed components, blocks (upper or lower), etc.

For example, in some embodiments, one or more of the upper appliances comprise a heterogeneous thickness, a heterogeneous stiffness, or a heterogeneous material composition as needed as part of the skeletal treatment plan. In some embodiments, the upper appliance comprises two or more of a heterogeneous thickness, a heterogeneous stiffness, or a heterogeneous material composition. In some embodiments, the unitary upper appliance comprises a heterogeneous thickness, a heterogeneous stiffness, and a heterogeneous material composition. The heterogeneous thickness, stiffness, and/or material composition can be configured to produce the force system for causing lateral expansion of the upper jaw and/or dental arch, e.g., by preferentially applying forces at certain locations on the teeth and/or upper palate. For example, an upper appliance with heterogeneous thickness may include thicker portions that apply more force on the teeth and/or palate than thinner portions. As another example, an appliance with heterogeneous stiffness can include stiffer portions that apply more force on the teeth and/or palate than more elastic portions. Variations in stiffness can be achieved by varying the unitary upper appliance thickness, material composition, and/or degree of photopolymerization, for example.

In some embodiments, determining an upper and/or lower appliance geometry and/or material composition comprises determining a geometry and/or material composition of one or more unitarily formed components to be directly fabricated with the appliance, such as one or more of upper blocks and lower blocks. Unitarily formed components may be any of the embodiments described herein. The geometry and/or material composition of unitarily formed component(s) can be selected to facilitate application of the force system to one or more of the patient's teeth and/or palate to cause skeletal correction. The material composition of unitarily formed components can be the same as or different from the material composition of the remainder of the appliance.

Step 806 may involve analyzing the desired force system in order to determine an upper and/or lower appliance geometry and material composition to produce the force system. In some embodiments, the analysis involves determining appliance properties (e.g., stiffness) at one or more locations that would produce a desired force at the one or more locations. The analysis can then involve determining an appliance geometry and material composition at the one or more locations to achieve the specified properties. Determination of the appliance geometry and material composition can be performed using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, Calif. For creating finite element models and analyzing them, program products from a number of vendors can be used, including finite element analysis packages from ANSYS, Inc., of Canonsburg, Pa., and SIMULIA (Abaqus) software products from Dassault Systèmes of Waltham, Mass.

Step 806 may include determining appliance geometries and/or material compositions for a series of pairs of upper appliances and lower appliances to produce the force system through a plurality of determined stages to produce the movement of the one or more bones along the movement path.

Optional step 808 in method 800 includes generating instructions for fabricating the upper and lower appliances, each having an appliance geometry and material composition, which may be performed at least partially within the skeletal treatment planning system 2030 in FIG. 20, such as in staging modules 2033.

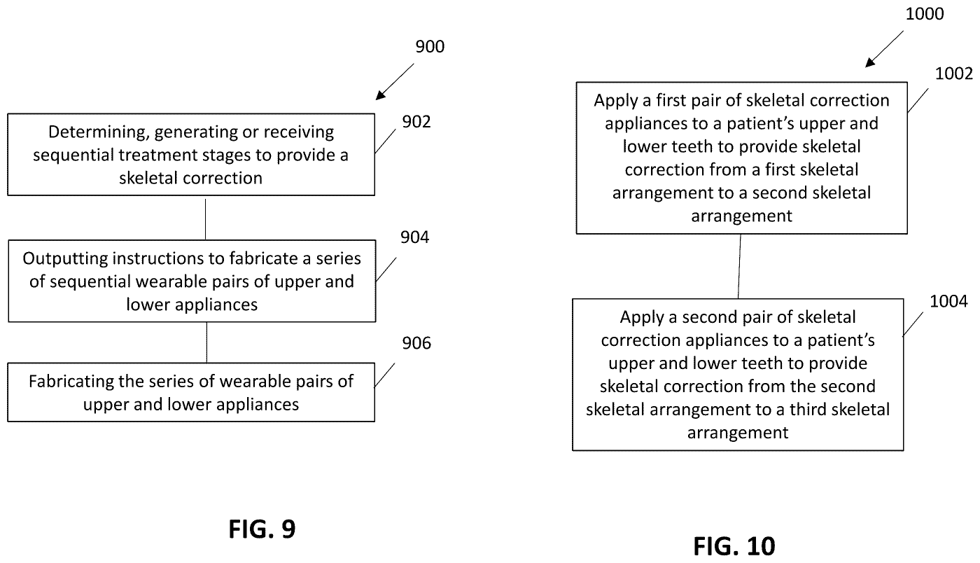

FIG. 9 illustrates an exemplary method 900 of fabricating one or more pairs of upper and lower appliances, wherein the one or more pairs may be pairs in a series of upper and lower skeletal correction appliances, any of which may be upper and lower appliances described herein. Method 900 includes, at step 902, determining, generating or receiving sequential treatment stages to provide a skeletal correction, which may be performed with skeletal treatment planning station 2030 in FIG. 20. Step 904 includes outputting instructions to fabricate a series of sequential wearable pairs of upper and lower appliances, which may be performed with skeletal treatment planning system 2030 in FIG. 20.

Step 906 includes fabricating the series of wearable pairs of upper and lower appliances, which may be performed with appliance fabrication system 2050 in FIG. 20.

FIG. 10 illustrates an exemplary method 1000 of multi-dimensional skeletal treatment, which may be performed when the patient wears any of the upper and lower appliance described herein as part of a skeletal treatment plan. Method 1000 includes step 1002 of applying a first pair of skeletal correction appliances to a patient's upper and lower teeth to provide skeletal correction from a first skeletal arrangement to a second skeletal arrangement. Step 1002 may, for example, occur during one or more stages as part of the treatment plan. Step 1004 includes applying a second pair of skeletal correction appliances to a patient's upper and lower teeth to provide skeletal correction from a second skeletal arrangement to a third skeletal arrangement. Step 1004 may, for example, occur during one or more stages as part of the treatment plan. Method 100, including steps 1002 and 1004 can be repeated as necessary using any suitable number and combination of sequential upper and lower appliances in order to incrementally reposition the skeleton from an initial skeletal arrangement to a target skeletal arrangement. A plurality of different appliances (e.g., a pair) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances).

For any of the determined stages described herein, and for any of the pairs of upper and lower appliances herein, the unitary upper appliance may be sized and shaped to cause lateral skeletal expansion of the upper jaw and the interface between the upper and lower blocks provides A-P skeletal correction between the mandible and the maxilla.

For any of the determined stages described herein, and for any of the pairs of upper and lower appliances herein, the upper appliance may be sized and shaped to cause lateral skeletal expansion of the upper jaw and the interface between the upper and lower blocks provides anterior movement of the mandible relative to the maxilla, optionally wherein the lateral skeletal expansion and the anterior movement of the mandible at least partially treats at least one of a Class II bite or OSA.

For any of the determined stages described herein, and for any of the pairs of upper and lower appliances herein, A-P skeletal correction between the mandible and the maxilla may comprise posterior movement of the mandible relative to the maxilla, optionally to at least partially treat a Class III bite.

For any of the determined stages described herein, and for any of the pairs of upper and lower appliances herein, A-P skeletal correction between the mandible and the maxilla may comprise anterior movement of the maxilla relative to the mandible.

For any of the determined stages described herein, and for any of the pairs of upper and lower appliances herein, A-P skeletal correction between the mandible and the maxilla may comprise posterior movement of the maxilla relative to the mandible.

For any of the determined stages described herein, and for any of the pairs of upper and lower appliances herein, the interface between the upper and lower blocks further provides vertical bite correction (e.g., expansion) between the maxilla and the mandible.

For any of the determined stages described herein, and for any of the pairs of upper and lower appliances herein, upper and lower blocks may each comprise occlusal blocks.

For any of the determined stages described herein, and for any of the pairs of upper and lower appliances herein, A-P skeletal correction may comprise any of the relative movements of the maxilla and mandible described herein.

Any of the determined treatment stages described herein may comprise lateral skeletal correction of the upper jaw without A-P skeletal correction.

Any of the determined treatment stages described herein may comprise A-P skeletal correction without lateral skeletal correction of the upper jaw, wherein the A-P skeletal correction may comprise any of the relative movements of the maxilla and mandible described herein.

Any of the determined treatment stages described herein may also include vertical bite skeletal correction.

Skeletal treatment plans herein may include determining one or more stages during which one or more types of skeletal correction occur simultaneously, wherein in at least part of the stage the different types of skeletal correction are provided by the upper and lower appliances. Determining the stages can include determining one or more of geometry and/or material for the upper and lower appliances for that stage to provide the one or more types of skeletal correction.

Skeletal treatment plans herein may include determining one or more stages during which one or more types of skeletal correction are provided without one or more other types of skeletal correction planned for that stage. Determining the stages can include determining one or more of geometry and/or material for the upper and lower appliances for that stage.

Skeletal treatment plans herein may include determining a particular type of skeletal corrections that is provided by the series of appliances in non-sequential stages. For example only, a first stage (not necessarily an initial stage) may include A-P skeletal correction, and a second stage may not provide A-P skeletal correction, and a third stage may provide A-P skeletal correction. Additionally, and for example only, any one or more of the first, second and third stages in this example may provide lateral upper jaw expansion, including in non-sequential stages.

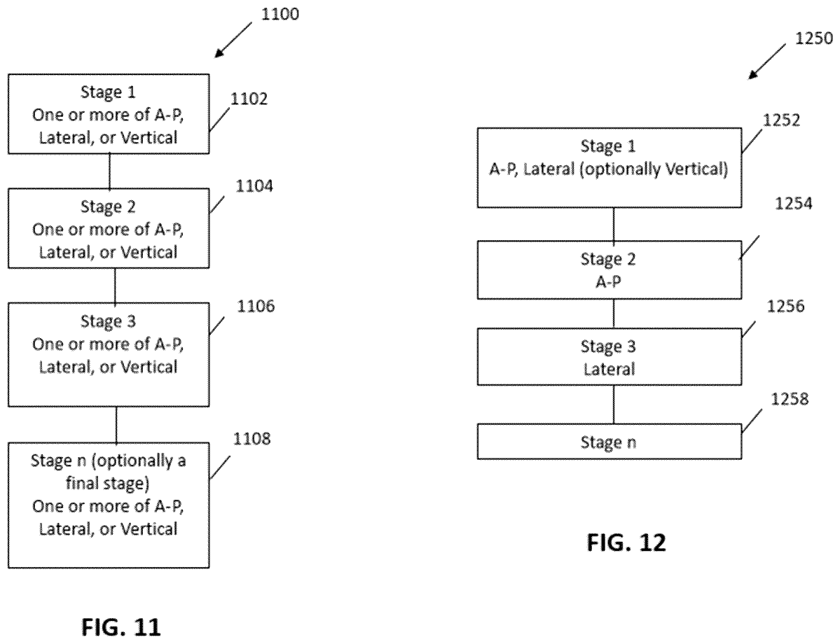

FIG. 11 illustrates an exemplary method 1100 that can be part of any of the skeletal treatment plans described herein. Method 1100 illustrates that different treatment stages may include one or more types of skeletal corrections according to the treatment plan. For example, in each of the stages 1102, 1104, 1106, 1108 one or more types of skeletal correction may be provided by the upper and lower appliances. Method 1100 provides an example of the robust treatment planning options and control provided by the multi-dimensional skeletal correction treatments described herein.

Generating or determining a skeletal treatment plan that comprises determining sequential treatment stages to provide the multi-dimensional skeletal correction, such as in step 708 of method 700, may include distinguishing one or more conditions from one or more other conditions in a way that influences one or more aspects of the planned sequential treatment stages. There may be a variety of ways of distinguishing conditions in this context. For example, distinguishing conditions may include determining that one or more conditions should be at least partially treated before the initiation of at least one other condition. Distinguishing conditions may include determining that one or more patient conditions are more severe that one or more other patient conditions and deserve a higher priority, emphasis, or weight in the skeletal treatment plan. Distinguishing may include determining that one or more conditions will require more time (either in absolute time (e.g., months, days, etc.) and/or in terms of the number of stages to correct than one or more other conditions (e.g., 5 stages versus 3 stages).

By way of example, if a patient is determined to have one or more conditions for which lateral and A-P skeletal correction are determined as part of the plan, the lateral correction and A-P correction may be distinguished, and the sequential treatment stages may reflect that the lateral correction (e.g., expansion) or the A-P correction should be corrected first, or at least initiated first. Alternatively, a lateral correction (e.g., expansion) and A-P correction may be at least partially treated simultaneously, such as occurring over the course of the same number of stages.

By way of example, if a patient is determined to have a Class II malocclusion, the treatment plan may include lateral correction A-P correction simultaneously, over at least some of the treatment stages.

By way of example, if a patient is determined to have a Class III malocclusion, the treatment plan may include A-P correction that includes one or more of anterior correction of the upper jaw and proximal correction of the mandible. For example, the upper and lower appliance may include reverse twin blocks to achieve the A-P skeletal correction. In this example, lateral expansion may be determined to be beneficial during one or more stages that include A-P correction.

By way of example, if a patient is determined to have a condition including a narrow arch, the skeletal treatment plan may distinguish lateral expansion as a priority compared to A-P skeletal correction. The skeletal treatment planning system in this example may, in the staging modules for example, determine that one or more initial stages should focus on or solely provide lateral expansion before any A-P skeletal correction. Generally, the treatment plan may focus more on intrapalatal expansion and less on mandibular advancement or mandibular retraction. In some treatment plans, lateral expansion may need to be performed first (or at least initiated first), before A-P correction is initiated. In this example, the environment can digitally program A-P correction to occur first, then arch expansion next, or alternatively they can be simultaneous as well.

In any of the treatment plans herein that include relative mandible anterior correction (or advancement), it may be necessary or beneficial to also expand the maxilla to compensate for the relative forward mandibular correction. These treatment plans may thus include both A-P correction and lateral expansion of the upper jaw, which may occur at least partially simultaneously during one or more stages, and/or some stages may only include one type of skeletal correction (e.g., A-P without lateral, or lateral without A-P).

FIG. 12 is an example of a method 1250 that can be part of skeletal treatment plans described herein. Method 1250 illustrates generally that some stages may include multiple types of skeletal correction, while other stages may include only one type of correction, according to and depending on the treatment plan. Step 1252 illustrates a plurality of types of correction, whereas steps 1254 and 1256 include only one type of correction. It is understood that other types of correction may be part of the any of the steps as needed or desired as part of the treatment plan. Subsequent stages (e.g. stage n) 1258 may be included and may correct one or more types of correction.

The disclosure herein generally refers to pairs of sequentially worn upper and lower appliances that are designed to be worn together as a pair as part of the overall treatment plan. However, determining a skeletal treatment plan may include determining that one of an upper or lower appliance should be worn in consecutive sequential stages (or that the geometry and/or material composition does not change even if a new appliance is provided), even if the other of the upper and lower appliance is replaced in the subsequent stage.

With some skeletal treatment plans, and depending on the determined stages, there may be one or more stages that include only an upper or only a lower appliance. For example, if a stage is only to provide lateral correction of an upper palate (without A-P correction during that stage, for example), an upper unitary appliance may be worn but a lower appliance may not be worn during that stage.

With some skeletal treatment plans, and depending on the determined stages, there may be one or more stages wherein the appliances are shells with one or more blocks that are configured to interface, where the upper appliance does not have a palatal region and is not adapted for lateral expansion.

### Additional Examples

In a first additional example of the skeletal treatments herein, the skeletal correction plan provides a system, device, and/or appliances to three-dimensionally enlarge a constricted airway by integrating Invisalign Palatal Expander (IPE) and Mandibular Advancement (MA) simultaneously. One or more of the appliances can be directly fabricated, such as by 3D printing. In this example, the three-dimensions to expand are (a) anterior-posterior (through the use of MA elements, e.g., PW or OB), (b) horizontally (e.g., through palatal expansion), and (c) a vertical bite dimension (through the use of MA elements, e.g., PW or OB). For the A-P direction, treatment stages can be determined, such as with the staging modules 2033 in FIG. 20.

The amounts of expansion and mandibular advancement are determined based on an orthodontic and/or skeletal correction goal and reduction of obstructive sleep apnea, which may be determined by doctors manually or by systems herein. The upper and lower appliances (e.g., optionally wherein the lower appliance is also a teeth aligner) may comprise one or more mandibular advancement structures (e.g., any of the blocks herein such as precision wings/buccal blocks and/or occlusal blocks, based on doctors' preference). The upper and lower appliances may be digitally designed and fabricated. It may be beneficial in these examples or for any appliance herein to be directly fabricated due based on potentially required stiffness and structural integrity. Any fabrication process may be used for the lower appliances, such as being thermormed or by direct fabrication.

The scanning systems herein may utilize CBCT, which can provide upper and lower jaw images as well as morphological information (e.g., cross-sectional area, minimum cross section, total volume, etc.) of one or more of the patient's airways, as illustrated in FIGS. 13 and 14. The images in FIGS. 13 and 14 are examples of one or more scanned images generated using skeletal scanning system 2010 in the environment 2000 in FIG. 20. Skeletal treatment planning system 2030 in FIG. 20 may receive one or more scans in FIGS. 13 and 14 (or similar scan data) and generate skeletal models, as described herein, which may be segmented and serve as the basis for staging modules described herein. The amounts of mandibular advancement and lateral expansion (and optionally vertical bite expansion) may be automatically estimated (such as with skeletal treatment planning system 2030 in FIG. 20) based on the scanned morphological information of airways obtained with CBCT, which may be based on a relationship between the skeletal changes with IPE and/or MA and the airway changes, which can be modeled/optimized with more clinical data (and optionally via Machine Learning, including patients' physiological information, e.g. BMI, age, gender, family history, life style, etc.).

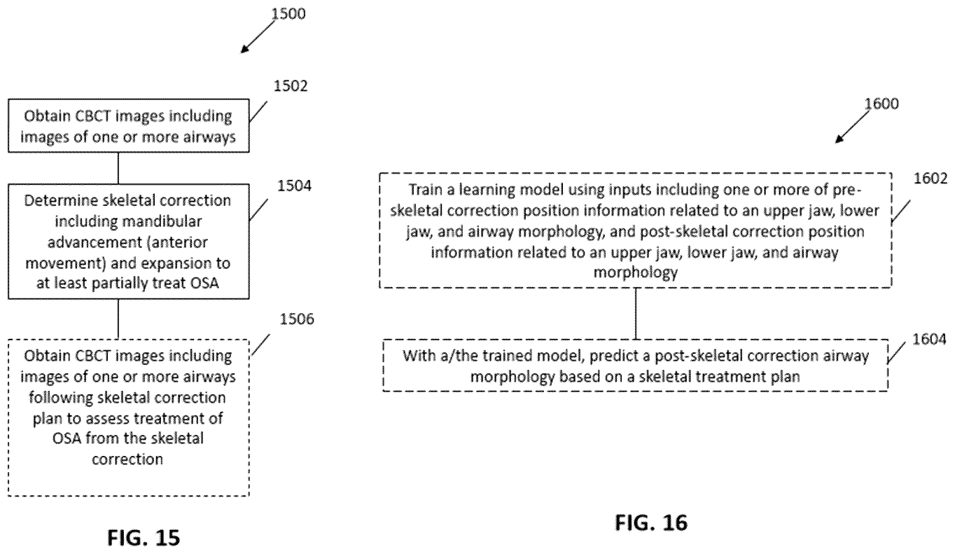

FIG. 15 illustrates an exemplary method 1500 that can be part of any of the skeletal treatment plans herein to treat OSA. In step 1502, one or more images are obtained using a CBCT scanner, which may be part of skeletal scanning system 2030 in FIG. 20. Based on and/or utilizing a digital model based on the CBCT scans, step 1504 includes determining skeletal correction including mandibular advancement (anterior movement) and lateral expansion to at least partially treat OSA, which may be performed with skeletal treatment planning system 2030 in FIG. 20. Optional step 1506 can obtain additional CBCT images including images of one or more airways following skeletal correction plan to assess treatment of OSA from the skeletal correction.

One aspect of the disclosure is training a machine learning model to, once trained, find parameters that can predict post skeletal-correction airway morphology, and provide a visualization of the predicted morphology to doctors before the skeletal correction treatment. The learning model/algorithm can be, for example, trained using inputs that include one or more of preskeletal position information related to the upper jaw, lower jaw, morphological information (e.g., cross-sectional area, minimum cross section, total volume, etc.) of one or more of the patient's airways, and post skeletal correction information related to the upper jaw, the lower jaw, and morphological information of one or more of the patient's airways. The training target can be post-skeletal airway morphology. Once trained, the trained model includes one or more parameters and can receive patient data including initial skeletal arrangement positional information related to the upper jaw, lower jaw and/or airway morphology, and predict a post-skeletal correction airway morphology based on a skeletal treatment plan. In general, the trained model can be adapted to predict the airway morphology of Post-skeletal change based on machine learning in a long run and visualize it to doctors before the skeletal treatment.

FIG. 16 illustrates an exemplary method 1600 that includes step 1602 of training a learning algorithm, and step 1604 of making a prediction of a post-skeletal correction airway morphology. Step 1602 and step 1604 do not need to be performed together as part of method 1600, as indicated by the dashed lines at both steps.

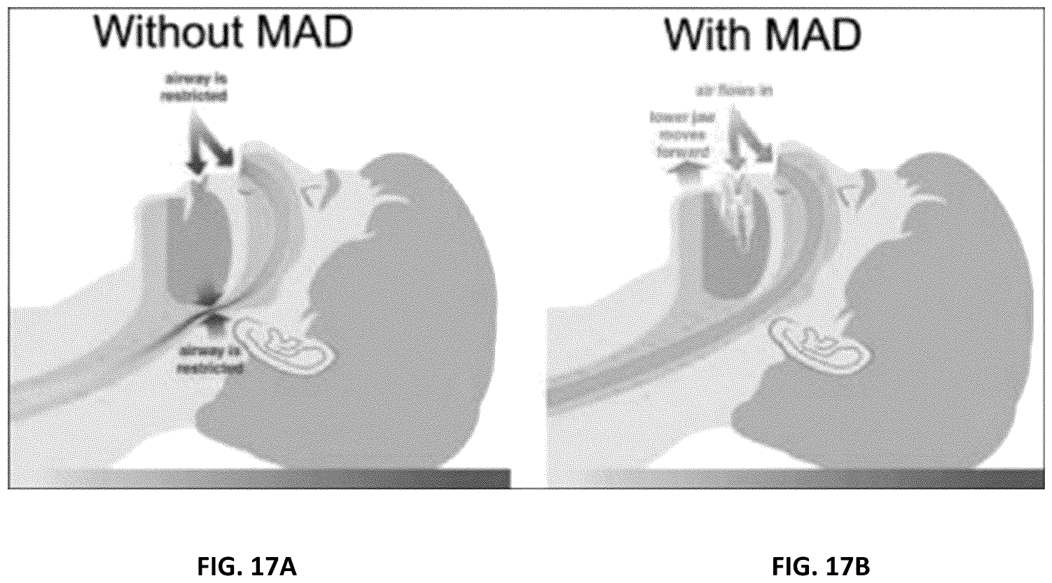

FIG. 17A illustrates a restricted upper airway of a subject without mandicular advancement, and FIG. 17B illustrates at least partial opening of the previously more restricted airway from FIG. 17A.

One aspect of the disclosure is a series of pairs of oral appliances, each pair configured to be sequentially worn by a patient as part of a skeletal treatment plan for multi-dimensional skeletal correction. Each pair may comprise, for one or more pairs in the series, an upper appliance having, a left tooth engagement region configured to be removably worn over a patient's teeth in a left portion of a patient's upper jaw; a right tooth engagement region configured to be removably worn over the patient's teeth in a right portion of the patient's upper jaw; a palatal region between the left tooth engagement region and the right tooth engagement region; and an upper block extending from the left or right tooth engagement region. Each pair may comprise, for one or more pairs in the series, a lower appliance configured to be removably worn over teeth in the patient's lower jaw, the lower appliance including a lower block, wherein, the upper and lower blocks each have at least one surface positioned and shaped to interface with a surface on the other of the upper and lower blocks, and over the course of a treatment time for the pair, the upper appliance is sized and shaped to provide lateral skeletal expansion of the upper jaw and/or the interface between the upper and lower blocks provides anterior-posterior (AP) skeletal correction between a mandible and a maxilla of the patient to at least partially treat the condition.

One aspect of the disclosure is a pair of oral appliances, wherein the pair is of a series of pairs of oral appliances. The pair may be any of the individual pairs of upper and lower appliances described herein.

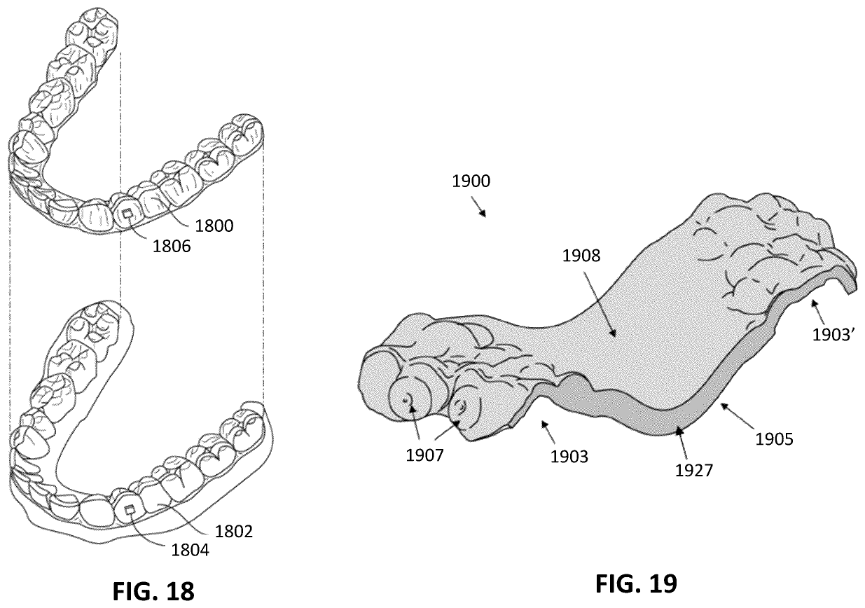

FIG. 18 illustrates a representative lower appliance that can be worn on lower teeth as part of any of the skeletal treatment plans herein. In some examples, the lower appliance can include a shell (e.g., a continuous polymeric shell or a segmented shell) having teeth-receiving cavities that receive and optionally also resiliently reposition the teeth. A lower appliance or portion(s) thereof may be indirectly fabricated using a physical model of teeth. For example, a lower appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance. A lower appliance can fit over all teeth present in lower jaw, or less than all of the teeth. The lower appliance can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the lower appliance can be a generic appliance configured to receive the teeth, but not necessarily shaped to match the topography of the patient's teeth. In some cases, only certain (or none) of the teeth received by a lower appliance will be repositioned by the appliance while other teeth can provide a base or anchor region for holding the appliance in place as it applies force against the tooth or teeth targeted for repositioning. In some cases, none of the teeth will be repositioned at some point during the skeletal correction treatment. Teeth that are moved can also serve as a base or anchor for holding the appliance as it is worn by the patient. Typically, no wires or other means will be provided for holding an appliance in place over the teeth. In some cases, however, it may be desirable or necessary to provide individual attachments or other anchoring elements 1804 on teeth 1802 with corresponding receptacles or apertures 1806 in the lower appliance 1800 so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

Appliance 1800 can include auxiliary components (e.g., features, accessories, structures, devices, components, and the like). Examples of such accessories include but are not limited to arch expanders, palatal expanders, twin blocks, occlusal blocks, bite ramps, mandibular advancement splints, bite plates, pontics, hooks, brackets, headgear tubes, springs, bumper tubes, palatal bars, frameworks, pin-and-tube apparatuses, buccal shields, buccinator bows, wire shields, lingual flanges and pads, lip pads or bumpers, protrusions, divots, and the like. For example, lower appliances herein are described as including one or more lower blocks, which are considered examples of auxiliary components.

Returning to FIGS. 2A and 3, upper appliance 200 (which in this example is unitary) and upper appliance 200′ includes optional anterior region 207. The anterior region 207 may include a plurality of cavities for receiving one or more anterior teeth (e.g., incisors, canines) of the upper jaw, which may help serve as anchoring locations for the upper appliance. All disclosure of appliance 1800 in FIG. 18, however, may be incorporated into the description of anterior region 207, which may be in any of the upper appliances herein. For example, anterior region 207 may be adapted to reposition one or more teeth like an aligner, it may be adapted for intrusion/extrusion movements, anterior intrusion or posterior extrusion, staging, etc. Anterior region 207 may be configured for vertical bite correction as well, which is described herein. For example, anterior region 207 may be configured for intrusion or extrusion of anterior teeth for vertical skeletal correction in one or more stages of the skeletal treatment plan.

In any of the treatment plans herein, and with any of the appliance herein, the appliances may include a lip bumper/check design and/or configuration. A lip bumper can be incorporated to restrict muscle tension and friction, which may help with comfort. The upper and/or lower appliance may include an element control the tongue. For example, hooks or bumps may be included on the lower anterior canine area to control the tongue. This may be more beneficial for class III malocclusions but may be utilized with any skeletal treatment plan herein. Any of the upper appliances herein may include one or more elements on the palate region, which may help to control Class III open bite.

Any of the upper appliances herein may include one or more retention elements, such as one or more retention attachments on molars.

Any of the skeletal correction treatments herein may include an approach that places an aligner over the upper unitary palatal expander. Activation can be done at the same time or at different times. In some examples, the aligner can mechanically latch to the upper palatal expander, which can be a clear aligner over a 3-D printed upper palatal expander. An aligner in these examples can help as a posterior anchor unit. The aligner can anchor the upper appliance and to assist with anterior control. The aligner may be like a transpalatal arch (e.g., 1-2 teeth wide, etc.). In these examples, the upper appliance and aligner may be 3D printed, or one part may be thermofromed and one part 3D printed.

The disclosure below is related general to upper appliances, and may be included in any of the upper appliances herein.

In general, the upper appliances described herein may include an offset between the upper surface of the mouth (the palatal surface) and the upper appliance. This offset may be, for example, between 0.1 mm and 10 mm (e.g., between 0.2 mm and 9 mm, between 0.3 mm and 9 mm, between 0.5 mm and 8 mm, between 1 mm and 7 mm, between 2 mm and 5 mm, etc., including any region or sub-regions there between). This gap may prevent soft tissue irritation. The gap may extend over 50% of the portion of the appliances that are positioned opposite of the patient's palate, when worn by the patient (e.g., over 60%, over 70%, over 80%, over 90%, over 95%, etc.). The gap may be centered in the mid-palatal region (e.g., along the mid-palatine suture, etc.). In some variations, the shape of the palatal portion of the upper appliance (e.g., the portion opposite the patient's palate when worn by the subject) may be contoured on the patient-facing side) to match the contour of the patient's palate (either with or without an offset, as just described) and may include ridges, channels, etc.

The upper appliances described herein may include a tooth engagement region for engaging at least a portion of the teeth in the patient's upper jaw, in particular the molars, and a palatal region extending between the tooth engaging region that is configured to be positioned adjacent and opposite from the patient's palate when the device is worn by the patient. For example, FIG. 19 shows an example of a portion of upper appliance 1900 (one or more blocks not included but may include any of the blocks or protrusions herein) that includes a pair of tooth engagement regions 1903, 1903′ on either side of the device, connected by a palatal region 1905. In this example, the upper appliance also includes a pair of attachment regions 1907 that may each enclose an attachment connector that is bonded to the patient's teeth, e.g., on either side of the device (on a buccal side of the patient's teeth; only one pair is visible). The attachment connector (also referred to herein as a connector, pin, attachment, or the like) may be secured to the teeth in a position that allows it to couple (e.g., removably couple) to the attachment region(s) on the expander. An attachment connector may be bonded (glued, etc.) to the teeth as part of an initial step prior to wearing the series of upper appliance. In the appliance shown in FIG. 19, the palatal region has a convex upper surface 1927 that is opposite the concave lower surface 1908. The lower surface is a lingual (tongue-facing) surface; the upper surface faces the palate.

The tooth engagement regions may be formed of the same material(s) as the palatal region, or they may include different materials. The thickness of the tooth engagement regions and the palatal regions may be different or the same. In particular, the palatal region may be thicker than the tooth engagement region. The thickness of the tooth engagement region may be thicker along the lateral (e.g., buccal and/or lingual) sides of the device and thinner (or removed from) across all or a portion of the top of the tooth engagement region. The palatal region may have a non-uniform thickness. For example, the upper appliance may be thicker near the midline of the device. Any of upper appliances may include ribs or other supports (e.g., extending transversely between the tooth engagement regions and/or perpendicular to the tooth engagement regions). These ribs may be formed of the same material as the rest of the upper appliance (e.g., but be thicker and/or shaped to have a cylindrical cross-sectional profile).

The inner (cavity) portion of the tooth engagement region is typically configured to conform to the outer contour of the patient's teeth, and to rest directly against the teeth and/or a portion of the gingiva (or to avoid the gingiva) to apply force thereto. The upper surface of the palatal region which is positioned adjacent to the palate when worn by the patient may be contoured to match the actual or predicted shape of the patient's palate. As mentioned above, all or a significant portion of the palatal region may be separated or spaced from the patient's palate when worn, which may enhance comfort and minimize disruption of speech.

In some variations, a portion of the palatal region extending between the opposite tooth engagement regions on either side of the device (e.g., a portion of the palatal region extending approximately z % of the distance between the tooth engagement regions, where z is greater than about 30%, 40%, 50%, 60%, 70%, 80%, 90%, etc.) may be flat or straight, rather than curved, so that it does not necessarily follow the contour of the patient's mouth. This portion may be one or more transverse ribs, struts or supports, or it may be the flat sheet. Such a flat or straight portion may provide increase force. Alternatively or additionally, the palatal region (e.g., one or more ribs, the sheet, etc.) may be curved in an arc similar to the arc of the patient's palate, but may have a much larger radius of curvature (appearing as a shallower concavity) than the patient's palate.

The methods and apparatuses described herein may be configured to design each upper appliance, including the stiffness and/or shape of the upper appliance (and in particular the palatal region, referred to herein as the IPA or interpalatal arch) by modeling skeletal movement, and applying constraints on the movements of the palate, teeth and/or gingiva in the jaw, including constrains (e.g., limits) on one or more of: the rate of movement of the two sides of the palate, the rate of expansion between the teeth (e.g., molars on opposite side of the patient's upper jaw), an amount of force applied to the patient's oral cavity, a rate of dental movement of the patient's teeth, and a rate of change of an angle between a left and a right portion of the palate. These constraints may be expressed as a limit on an increment of change of these movements. The patient's age may also be used to model or simulate movement of the palate and/or teeth.

A series of upper appliances as described herein may be configured to expand the patient's palate by a predetermined distance (e.g., the distance between the molar regions of one upper appliance may differ from the distance between the molar regions of the prior upper appliance by not more than 2 mm, by between 0.1 and 2 mm, by between 0.25 and 1 mm, etc.) and/or by a predetermined force (e.g., limiting the force applied to less than 100 Newtons (N), to between 8-100 N, between 8-90 N, between 8-80 N, between 8-70 N, between 8-60 N, between 8-50 N, between 8-40 N, between 8-30 N, between 30-60N, between 30-70N, between 40-60N, between 40-70N, between 60-200 N, between 70-180 N, between 70-160 N, etc., including any range there between). These devices and apparatuses may be configured to limit the movement and/or forces applied to within these ranges.

In any of the apparatuses described herein (and methods of fabricating them), the upper appliance may be formed out of a polymer and/or a metal material, including stainless steel, nickel titanium, copper nickel titanium, etc. In particular, described herein are laminated apparatuses, in which the upper appliances are formed with layers of material that may be formed and/or adhered together (e.g., to form an integrated device); different layers may have different mechanical and/or chemical properties, and may include different thicknesses or regions of thickness. For example, an upper appliance may include laminated materials that are bonded together.

The upper appliances and method of forming them may include fabricating one or more of the expanders by direct fabrication techniques. For example, an apparatus (including a series of upper appliances) may be digitally designed and fabricated by a direct printing (e.g., 3D printing); alternatively or additionally the fabrication method may include 3D printing of models of the teeth, gingiva and palate that have been digitally configured to form one or more of the series applying the lateral expansion.

The tooth engagement regions of the upper appliances herein may comprise an occlusal side and a buccal side, further wherein the occlusal side may have a different thickness (e.g., may be thinner) than the palatal region, and the buccal side may have a different thickness (e.g., may be thinner) than the occlusal side.

### Methods of Manufacturing/Fabrication

The various embodiments of the appliances presented herein can be fabricated in a wide variety of ways. In some embodiments, the appliances herein (or portions thereof) can be produced using direct fabrication, such as additive manufacturing techniques (also referred to herein as “3D printing) or subtractive manufacturing techniques (e.g., milling). In some embodiments, direct fabrication involves forming an object (e.g., an appliance or a portion thereof) without using a physical template (e.g., mold, mask etc.) to define the object geometry. Additive manufacturing techniques can be categorized as follows: (1) vat photopolymerization (e.g., stereolithography), in which an object is constructed layer by layer from a vat of liquid photopolymer resin; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) fused deposition modeling (FDM), in which material is drawn though a nozzle, heated, and deposited layer by layer; (5) powder bed fusion, including but not limited to direct metal laser sintering (DMLS), electron beam melting (EBM), selective heat sintering (SHS), selective laser melting (SLM), and selective laser sintering (SLS); (6) sheet lamination, including but not limited to laminated object manufacturing (LOM) and ultrasonic additive manufacturing (UAM); and (7) directed energy deposition, including but not limited to laser engineering net shaping, directed light fabrication, direct metal deposition, and 3D laser cladding. For example, stereolithography can be used to directly fabricate one or more of the appliances herein. In some embodiments, stereolithography involves selective polymerization of a photosensitive resin (e.g., a photopolymer) according to a desired cross-sectional shape using light (e.g., ultraviolet light). The object geometry can be built up in a layer-by-layer fashion by sequentially polymerizing a plurality of object cross-sections. As another example, the appliances herein can be directly fabricated using selective laser sintering. In some embodiments, selective laser sintering involves using a laser beam to selectively melt and fuse a layer of powdered material according to a desired cross-sectional shape in order to build up the object geometry. As yet another example, the appliances herein can be directly fabricated by fused deposition modeling. In some embodiments, fused deposition modeling involves melting and selectively depositing a thin filament of thermoplastic polymer in a layer-by-layer manner in order to form an object. In yet another example, material jetting can be used to directly fabricate the appliances herein. In some embodiments, material jetting involves jetting or extruding one or more materials onto a build surface in order to form successive layers of the object geometry.

In some embodiments, the direct fabrication methods provided herein build up the object geometry in a layer-by-layer fashion, with successive layers being formed in discrete build steps. Alternatively or in combination, direct fabrication methods that allow for continuous build-up of an object's geometry can be used, referred to herein as “continuous direct fabrication.” Various types of continuous direct fabrication methods can be used. As an example, in some embodiments, the appliances herein are fabricated using “continuous liquid interphase printing,” in which an object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Continuous liquid interphase printing can achieve fabrication speeds about 25 times to about 100 times faster than other direct fabrication methods, and speeds about 1000 times faster can be achieved with the incorporation of cooling systems. Continuous liquid interphase printing is described in U.S. Patent Publication Nos. 2015/0097315, 2015/0097316, and 2015/0102532, the disclosures of each of which are incorporated herein by reference in their entirety.

As another example, a continuous direct fabrication method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety.

In another example, a continuous direct fabrication method can involve extruding a composite material composed of a curable liquid material surrounding a solid strand. The composite material can be extruded along a continuous three-dimensional path in order to form the object. Such methods are described in U.S. Patent Publication No. 2014/0061974, the disclosure of which is incorporated herein by reference in its entirety.

In yet another example, a continuous direct fabrication method utilizes a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

The direct fabrication approaches provided herein are compatible with a wide variety of materials, including but not limited to one or more of the following: polymer matrix reinforced with ceramic or metallic polymers, a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, a thermoplastic polyamide elastomer, or combinations thereof. The materials used for direct fabrication can be provided in an uncured form (e.g., as a liquid, resin, powder, etc.) and can be cured (e.g., by photopolymerization, light curing, gas curing, laser curing, crosslinking, etc.) in order to form an appliance or a portion thereof. The properties of the material before curing may differ from the properties of the material after curing. Once cured, the materials herein can exhibit sufficient strength, stiffness, durability, biocompatibility, etc. for use in an orthodontic appliance. The post-curing properties of the materials used can be selected according to the desired properties for the corresponding portions of the appliance.

In some embodiments, relatively rigid portions of the appliance can be formed via direct fabrication using one or more of the following materials: a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, and/or a polytrimethylene terephthalate.

In some embodiments, relatively clastic portions of the appliance can be formed via direct fabrication using one or more of the following materials: a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, and/or a thermoplastic polyamide elastomer.

Optionally, the direct fabrication methods described herein allow for fabrication of an appliance including multiple materials, referred to herein as “multi-material direct fabrication.” In some embodiments, a multi-material direct fabrication method involves concurrently forming an object from multiple materials in a single manufacturing step using the same fabrication machine and method. For instance, a multi-tip extrusion apparatus can be used to selectively dispense multiple types of materials (e.g., resins, liquids, solids, or combinations thereof) from distinct material supply sources in order to fabricate an object from a plurality of different materials. Such methods are described in U.S. Pat. No. 6,749,414, the disclosure of which is incorporated herein by reference in its entirety. Alternatively or in combination, a multi-material direct fabrication method can involve forming an object from multiple materials in a plurality of sequential manufacturing steps. For instance, a first portion of the object can be formed from a first material in accordance with any of the direct fabrication methods herein, then a second portion of the object can be formed from a second material in accordance with methods herein, and so on, until the entirety of the object has been formed. The relative arrangement of the first and second portions can be varied as desired, e.g., the first portion can be partially or wholly encapsulated by the second portion of the object. The sequential manufacturing steps can be performed using the same fabrication machine or different fabrication machines, and can be performed using the same fabrication method or different fabrication methods. For example, a sequential multi-manufacturing procedure can involve forming a first portion of the object using stereolithography and a second portion of the object using fused deposition modeling.

Direct fabrication can provide various advantages compared to other manufacturing approaches. For instance, in contrast to indirect fabrication, direct fabrication permits production of an orthodontic appliance without utilizing any molds or templates for shaping the appliance, thus reducing the number of manufacturing steps involved and improving the resolution and accuracy of the final appliance geometry. Additionally, direct fabrication permits precise control over the three-dimensional geometry of the appliance, such as the appliance thickness. Complex structures and/or auxiliary components can be formed integrally as a single piece with the appliance shell in a single manufacturing step, rather than being added to the shell in a separate manufacturing step. In some embodiments, direct fabrication is used to produce appliance geometries that would be difficult to create using alternative manufacturing techniques, such as appliances with very small or fine features, complex geometric shapes, undercuts, interproximal structures, shells with variable thicknesses, and/or internal structures (e.g., for improving strength with reduced weight and material usage). For example, in some embodiments, the direct fabrication approaches herein permit fabrication of an appliance with feature sizes of less than or equal to about 5 μm, or within a range from about 5 μm to about 50 μm, or within a range from about 20 μm to about 50 μm.

In some embodiments, the direct fabrication methods described herein implement process controls for various machine parameters of a direct fabrication system or device in order to ensure that the resultant appliances are fabricated with a high degree of precision. Such precision can be beneficial for ensuring accurate delivery of a desired force system to the teeth in order to effectively elicit tooth movements. Process controls can be implemented to account for process variability arising from multiple sources, such as the material properties, machine parameters, environmental variables, and/or post-processing parameters.

Material properties may vary depending on the properties of raw materials, purity of raw materials, and/or process variables during mixing of the raw materials. In many embodiments, resins or other materials for direct fabrication should be manufactured with tight process control to ensure little variability in photo-characteristics, material properties (e.g., viscosity, surface tension), physical properties (e.g., modulus, strength, elongation) and/or thermal properties (e.g., glass transition temperature, heat deflection temperature). Process control for a material manufacturing process can be achieved with screening of raw materials for physical properties and/or control of temperature, humidity, and/or other process parameters during the mixing process. By implementing process controls for the material manufacturing procedure, reduced variability of process parameters and more uniform material properties for each batch of material can be achieved. Residual variability in material properties can be compensated with process control on the machine, as discussed further herein.

Machine parameters can include curing parameters. For digital light processing (DLP)-based curing systems, curing parameters can include power, curing time, and/or grayscale of the full image. For laser-based curing systems, curing parameters can include power, speed, beam size, beam shape and/or power distribution of the beam. For printing systems, curing parameters can include material drop size, viscosity, and/or curing power. These machine parameters can be monitored and adjusted on a regular basis (e.g., some parameters at every 1-x layers and some parameters after each build) as part of the process control on the fabrication machine. Process control can be achieved by including a sensor on the machine that measures power and other beam parameters every layer or every few seconds and automatically adjusts them with a feedback loop. For DLP machines, gray scale can be measured and calibrated before, during, and/or at the end of each build, and/or at predetermined time intervals (e.g., every n^{th} build, once per hour, once per day, once per week, etc.), depending on the stability of the system. In addition, material properties and/or photo-characteristics can be provided to the fabrication machine, and a machine process control module can use these parameters to adjust machine parameters (e.g., power, time, gray scale, etc.) to compensate for variability in material properties. By implementing process controls for the fabrication machine, reduced variability in appliance accuracy and residual stress can be achieved.

In many embodiments, environmental variables (e.g., temperature, humidity, Sunlight or exposure to other energy/curing source) are maintained in a tight range to reduce variable in appliance thickness and/or other properties. Optionally, machine parameters can be adjusted to compensate for environmental variables.

In many embodiments, post-processing of appliances includes cleaning, post-curing, and/or support removal processes. Relevant post-processing parameters can include purity of cleaning agent, cleaning pressure and/or temperature, cleaning time, post-curing energy and/or time, and/or consistency of support removal process. These parameters can be measured and adjusted as part of a process control scheme. In addition, appliance physical properties can be varied by modifying the post-processing parameters. Adjusting post-processing machine parameters can provide another way to compensate for variability in material properties and/or machine properties.

Although various embodiments herein are described with respect to optional direct fabrication techniques, it shall be appreciated that other techniques can also be used, such as indirect fabrication techniques. In some embodiments, the appliances herein (or portions thereof) can be produced using indirect fabrication techniques, such as by thermoforming over a positive or negative mold. Indirect fabrication of an orthodontic appliance can involve one or more of the following steps: producing a positive or negative mold of the patient's dentition in a target arrangement (e.g., by additive manufacturing, milling, etc.), thermoforming one or more sheets of material over the mold in order to generate an appliance shell, forming one or more structures in the shell (e.g., by cutting, etching, etc.), and/or coupling one or more components to the shell (e.g., by extrusion, additive manufacturing, spraying, thermoforming, adhesives, bonding, fasteners, etc.). Optionally, one or more auxiliary appliance components as described herein (e.g., elastics, wires, springs, bars, arch expanders, palatal expanders, twin blocks, occlusal blocks, bite ramps, mandibular advancement splints, bite plates, pontics, hooks, brackets, headgear tubes, bumper tubes, palatal bars, frameworks, pin-and-tube apparatuses, buccal shields, buccinator bows, wire shields, lingual flanges and pads, lip pads or bumpers, protrusions, divots, etc.) are formed separately from and coupled to the appliance shell (e.g., via adhesives, bonding, fasteners, mounting features, etc.) after the shell has been fabricated.

In some embodiments, the upper and lower appliances herein can be fabricated using a combination of direct and indirect fabrication techniques, such that different portions of an appliance can be fabricated using different fabrication techniques and assembled in order to form the final appliance. For example, an appliance shell can be formed by indirect fabrication (e.g., thermoforming), and one or more structures or components as described herein (e.g., auxiliary components, power arms, etc.) can be added to the shell by direct fabrication (e.g., printing onto the shell).

The configuration of the upper and lower appliances herein can be determined according to a treatment plan for a patient, e.g., a treatment plan involving successive administration of a plurality of appliances for incrementally repositioning teeth. Computer-based treatment planning and/or appliance manufacturing methods can be used in order to facilitate the design and fabrication of appliances. For instance, one or more of the appliance components described herein can be digitally designed and fabricated with the aid of computer-controlled manufacturing devices (e.g., computer numerical control (CNC) milling, computer-controlled additive manufacturing such as 3D printing, etc.). The computer-based methods presented herein can improve the accuracy, flexibility, and convenience of appliance fabrication.

In some embodiments, computer-based 3-dimensional planning/design tools, such as Treat™ software from Align Technology, Inc., may be used to design and fabricate the upper and lower appliances described herein.

In general, these methods and apparatuses (systems, devices, etc., including software, hardware and/or firmware) may be used at one or more parts of a skeletal computing environment, including as part of a skeletal scanning system, doctor system, treatment planning (e.g., technician) system, patient system, and/or fabrication system.

FIG. 20 is a diagram illustrating one variation of a computing environment 2000 that may generate one or more skeletal treatment plans specific to a patient, and fabricate upper and lower appliances that may accomplish the skeletal treatment plan to treat a patient, under the direction of a dental professional. The example computing environment 2000 shown in FIG. 20 includes a skeletal scanning system 2010, a doctor system 2020, a skeletal treatment planning system 2030 (e.g., technician system), a patient system 2040, an appliance fabrication system 2050, and computer-readable medium 2060. Each of these systems may be referred to equivalently as a sub-system of the overall system (e.g., computing environment). Although shown as discrete systems, some or all of these systems may be integrated and/or combined. In some variations a computing environment (skeletal computing system) 2000 may include just one or a subset of these systems (which may also be referred to as sub-systems of the overall system 2000). As mentioned, one or more of these systems may be combined or integrated with one or more of the other systems (sub-systems), such as, e.g., the patient system and the doctor system may be part of a remote server accessible by doctor and/or patient interfaces. The computer readable medium 2060 may divided between all or some of the systems (subsystems); for example, the skeletal treatment planning system and appliance fabrication system may be part of the same sub-system and may be on a computer readable medium 2060. Further, each of these systems may be further divided into sub-systems or components that may be physically distributed (e.g., between local and remote processors, etc.) or may be integrated.

A skeletal scanning system may include one or more skeletal scanners 2011 as well as one or more processors for processing images. For example, a skeletal scanning system 2010 can include a computed tomography system such as a CBCT system, etc.), processor(s) 2012, a memory 2013, scan capture module 2014, and outcome simulation module 2015. In general, the skeletal scanning system 2010 can capture one or more images of an upper and lower jaw and/or tissue proximate to and optionally defining one more upper airways. Use of the skeletal scanning system 2010 may optionally be in a clinical setting (doctor's office or the like). In some cases, operations of the skeletal scanning system 2010 may be performed by a doctor or other trained dental professional.

The skeletal scanner may be adapted for radiographic imaging, and optionally to perform tomography, such as computed tomography. The skeletal scanner may be a cone beam computed tomography (CBCT) scanner. The scan capture module 2014 can include instructions (such as non-transitory computer-readable instructions) that may be stored in the memory 2013 and executed by the processor(s) 2012 to control the capture of any number of skeletal images.

For example, the outcome simulation module 2015, which may be part of the skeletal scanning system 2010, can include instructions that simulate the positions of one or more bones and/or teeth based on a skeletal treatment plan. Alternatively or additionally, in some examples, the outcome simulation module 2015 can import skeletal information from 3D models onto 2D images to assist in determining an outcome simulation.

Any of the component systems or sub-systems of the skeletal computing environment 2000 may access or use a skeletal 3D model of the patient generated by the methods and apparatuses described herein. For example, the doctor system 2020 may include a treatment management module 2021 and a CBCT capture module 2022 that may access or use the 3D model. The doctor system 2020 may provide a “doctor facing” interface to the computing environment 2000. The treatment management module 2021 can perform any operations that enable a doctor or other clinician to manage the treatment of any patient. In some examples, the treatment management module 2021 may provide a visualization and/or simulation of the patient's skeleton with respect to a treatment plan.

The CBCT capture module 2022 can provide images of the patient's skeleton to a clinician through the doctor system 2020. The images may be captured through the skeletal scanning system 2010 and may also include images of a simulation of skeletal movement based on a treatment plan.

In some examples, the treatment management module 2021 can enable the doctor to modify or revise a skeletal treatment plan, particularly when images provided by the CBCT capture module 2022 indicate that the movement of one or more aspects of the patient's skeleton may not be according to the skeletal treatment plan. The doctor system 2020 may include one or more processors configured to execute any feasible non-transitory computer-readable instructions to perform any feasible operations described herein.

Alternatively or additionally, the skeletal treatment planning system 2030 may include any of the methods and apparatuses described herein. The skeletal treatment planning system 2030 may include skeletal scan processing/detailing module 2031, segmentation module 2032, staging module 2033, skeletal treatment monitoring module 2034, and skeletal treatment planning database(s) 2035. In general, the treatment planning system 2030 can determine a treatment plan for any feasible patient. The skeletal scan processing/detailing module 2031 can receive or obtain skeletal scans (such as scans from the skeletal scanning system 2010) and can process the scans to “clean” them by removing scan errors and, in some cases, enhancing details of the scanned image. The treatment planning system 2030 may perform segmentation. For example, a skeletal treatment planning system may include a segmentation module 2032 that can segment a skeletal model into separate parts including one or more of teeth, upper and lower jaw bones, and the like. In some cases, the skeletal models may be based on scan data from the skeletal scan processing/detailing module 2031.

The skeletal staging module 2033 may determine different stages of a skeletal treatment plan. Each stage may correspond to a different pair of upper and lower appliances, as described herein. The staging module 2033 may also determine the final skeletal position, in accordance with a skeletal treatment plan. Thus, the skeletal staging module 2033 can determine some or all of a patient's skeletal treatment plan. In some examples, the skeletal staging module 2033 can simulate movement of one or more parts of the patient's skeleton (bones and/or teeth) in accordance with the different stages of the patient's skeletal treatment plan.

The skeletal treatment monitoring module 2034 can monitor the progress of a skeletal treatment plan. In some examples, the treatment monitoring module 2034 can provide an analysis of progress of treatment plans to a clinician. The skeletal treatment plans may be stored in the skeletal treatment planning database(s) 2035. Although not shown here, the skeletal treatment planning system 2030 can include one or more processors configured to execute any feasible non-transitory computer-readable instructions to perform any feasible operations described herein.

The patient system 2040 can include a treatment visualization module 2041 and a skeletal state capture module 2042. In general, the patient system 2040 can provide a “patient facing” interface to the computing environment 2000. The treatment visualization module 2041 can enable the patient to visualize how a skeletal treatment plan has progressed and also visualize a predicted outcome (e.g., a final position of teeth).

In some examples, the patient system 2040 can capture skeletal scans for the treatment visualization module 2041 through the skeletal capture module 2042. The skeletal state capture module can enable a patient to capture his or her own skeleton (e.g., bones and/or dentition) through the skeletal scanning system 2010. Although not shown here, the patient system 2040 can include one or more processors configured to execute any feasible non-transitory computer-readable instructions to perform any feasible operations described herein.

The appliance fabrication system 2050 can include appliance fabrication machinery 2051, processor(s) 2052, memory 2053, and appliance generation module 2054. In general, the appliance fabrication system 2050 can directly or indirectly fabricate upper and/or lower appliances to implement a skeletal treatment plan. In some examples, the skeletal treatment plan may be stored in the skeletal treatment planning database(s) 2035.

The appliance fabrication machinery 2051 may include any feasible implement or apparatus that can fabricate any suitable upper and/or lower appliance. The appliance generation module 2054 may include any non-transitory computer-readable instructions that, when executed by the processor(s) 2052, can direct the appliance fabrication machinery 2051 to produce one or more appliances. The memory 2053 may store data or instructions for use by the processor(s) 2052. In some examples, the memory 2053 may temporarily store a skeletal plan, skeletal models, or skeletal scans.

The computer-readable medium 2060 may include some or all of the elements described herein with respect to the computing environment 2000. The computer-readable medium 2060 may include non-transitory computer-readable instructions that, when executed by a processor, can provide the functionality of any device, machine, or module described herein.

All publications and patent applications mentioned in this specification are herein incorporated by reference in their entirety to the same extent as if each individual publication or patent application was specifically and individually indicated to be incorporated by reference. Furthermore, it should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of generating a skeletal treatment plan for multi-dimensional skeletal correction of a patient, comprising:
receiving or generating a digital skeletal representation of at least an upper jaw and a lower jaw of a patient;
determining, based on the digital representation, if the patient has at least one of: an oral skeletal condition or an airway condition;
determining an amount of multi-dimensional skeletal correction between an initial skeletal arrangement and a target skeletal arrangement to treat the at least one condition;
determining, based on the determined amount of multi-dimensional skeletal correction to treat the at least one condition, a skeletal treatment plan comprising determining sequential treatment stages to provide the multi-dimensional skeletal correction, wherein the sequential treatment stages comprise a series of wearable pairs of an upper appliance and a lower appliance, that when sequentially worn by the patient, provide the multi-dimensional skeletal correction; and
outputting instructions to fabricate the series of wearable pairs of upper appliances and lower appliances.

2. The method of claim 1, wherein the multi-dimensional skeletal correction includes an amount of lateral skeletal correction to an upper jaw, an amount of anterior-posterior (AP) skeletal correction of one or both of the patient's mandible or maxilla, and an amount of vertical skeletal correction between the mandible and the maxilla, or any combination of the lateral, skeletal and vertical skeletal corrections.

3. The method of claim 1, wherein the series of wearable pairs comprises wearable pairs of a unitary upper application and a lower appliance.

4. The method of claim 1, wherein the at least one of the oral skeletal condition or the airway condition comprises obstructive sleep apnea (OSA), and/or one of a Class II bite or a Class III bite.

5. The method of claim 1, wherein outputting instructions to fabricate the series of wearable pairs of upper appliances and lower appliances comprises fabricating the series of pairs of upper appliances and lower appliances.

6. The method of claim 5, wherein fabricating comprises using an additively manufacturing process to fabricate the upper appliances.

7. The method of claim 5, wherein fabricating comprises using a process that deposits an appliance material layer by layer and cures the appliance material.

8. The method of claim 1, wherein receiving or generating a digital skeletal representation of at least an upper jaw and a lower jaw of a subject further comprising receiving or generating a digital representation of a portion of the patient's upper airway.

9. The method of claim 1, wherein receiving or generating the digital skeletal representation of at least the upper jaw and the lower jaw of a patient comprises receiving a cone-beam computed tomography (CBCT) scan.

10. The method of claim 1, wherein receiving or generating the digital skeletal representation comprises receiving or generating the digital representation from cone-beam computed tomography (CBCT).

11. The method of claim 1, wherein, for each of the pairs, the upper appliance comprises a left tooth engagement region, a right tooth engagement region, a palatal region between the left tooth engagement region and the right tooth engagement region, and an upper block extending from the left or right tooth engagement region, and the lower appliance is configured to be removably worn over teeth in the patient's lower jaw, the lower appliance including a lower block, and over the course of a treatment time for the pair, the upper appliance is sized and shaped to cause lateral skeletal expansion of the upper jaw, and/or the interface between the upper and lower blocks provides anterior-posterior (AP) skeletal correction between a mandible and a maxilla of the patient.

12. The method of claim 11, wherein, over the course of the treatment time for the pair, the upper appliance is sized and shaped to cause lateral skeletal expansion of the upper jaw and the interface between the upper and lower blocks provides AP skeletal correction between the mandible and the maxilla.

13. The method of claim 11, wherein AP skeletal correction between the mandible and the maxilla comprises anterior movement of the mandible relative to the maxilla.

14. The method of claim 13, wherein the lateral skeletal expansion and the anterior movement of the mandible treat at least one of a Class II bite or OSA.

15. The method of claim 11, wherein AP skeletal correction between the mandible and the maxilla comprises posterior movement of the mandible relative to the maxilla, optionally to treat a Class III bite.

16. The method of claim 11, wherein AP skeletal correction between the mandible and the maxilla comprises anterior movement of the maxilla relative to the mandible.

17. The method of claim 11, wherein AP skeletal correction between the mandible and the maxilla comprises posterior movement of the maxilla relative to the mandible.

18. The method of claim 1, wherein, over the course of the treatment time for the pair, the interface between the upper and lower blocks further provides vertical skeletal expansion between the maxilla and the mandible.

19. The method of claim 18, wherein the upper and lower blocks each comprise occlusal blocks.

20. The method of claim 1, wherein the lower appliance comprises a shell with a plurality of cavities each configured to receive therein a lower jaw tooth, wherein the lower blocks extends from an occlusal and/or buccal surface of the lower appliance.

21. The method of claim 1, wherein the treatment plan comprises at least one stage with simultaneous lateral skeletal correction of the upper jaw and AP skeletal correction.

22. The method of claim 1, wherein the treatment plan comprises at least one stage with lateral skeletal correction without AP skeletal correction.

23. The method of claim 1, wherein the treatment plan comprises at least stage with AP skeletal correction without lateral skeletal correction.

24. A system comprising:
one or more processors;
a memory coupled to the one or more processors, the memory storing computer-program instructions, that, when executed by the one or more processors, perform a computer-implemented method comprising:
receiving or generating a digital skeletal representation of at least an upper jaw and a lower jaw of a patient;
determining, based on the digital representation, if the patient has at least one of: an oral skeletal condition or an airway condition;
determining an amount of multi-dimensional skeletal correction between an initial skeletal arrangement and a target skeletal arrangement to treat the at least one condition;
determining, based on the determined amount of multi-dimensional skeletal correction to treat the at least one condition, a skeletal treatment plan comprising determining sequential treatment stages to provide the multi-dimensional skeletal correction, wherein the sequential treatment stages comprise a series of wearable pairs of an upper lateral expansion appliance and a lower appliance, that when sequentially worn by the patient, provide the multi-dimensional skeletal correction; and
outputting instructions to fabricate the series of wearable pairs of upper appliances and lower appliances.

25. A series of pairs of oral appliances, each pair configured to be sequentially worn by a patient as part of a skeletal treatment plan for multi-dimensional skeletal correction, each pair comprising, for one or more pairs in the series:
an upper appliance having:
a left tooth engagement region configured to be removably worn over a patient's teeth in a left portion of a patient's upper jaw;
a right tooth engagement region configured to be removably worn over the patient's teeth in a right portion of the patient's upper jaw;
a palatal region between the left tooth engagement region and the right tooth engagement region; and
an upper block extending from the left or right tooth engagement region; and
a lower appliance configured to be removably worn over teeth in the patient's lower jaw, the lower appliance including a lower block, wherein,
the upper and lower blocks each have at least one surface positioned and shaped to interface with a surface on the other of the upper and lower blocks, and
over the course of a treatment time for the pair, the upper appliance is sized and shaped to provide lateral skeletal expansion of the upper jaw and/or the interface between the upper and lower blocks provides anterior-posterior (AP) skeletal correction between a mandible and a maxilla of the patient to at least partially treat the condition.
